(19) United States
(12) Patent Application Publication
(10) Pub. No.: US 2026/0149582 A1
(43) Pub. Date: May 28, 2026

(54) END-TO-END ENCRYPTION FOR TEAMS UTILIZING A TEAM-BASED STRATIFIED KEY STRUCTURE

(71) Applicant: Dropbox, Inc., San Francisco, CA (US)

(72) Inventors: Andrea Baumann, Krumbach (DE); Andrea Pfundmeier, Bobingen (DE); Bernhard Förster, Augsburg (DE); Boris Schlosser, Krumbach (DE); Christian Olbrich, Passau (DE); David Aeschlimann; Nicole Weiß, Augsburg (DE); Philip Lenzen, Augsburg (DE); Robert Freudenreich, Augsburg (DE); Stefan Wollny, Augsburg (DE)

(21) Appl. No.: 18/959,081

(22) Filed: Nov. 25, 2024

(51) Int. Cl. H04L 9/14

(52) U.S. Cl. CPC H04L 9/14

(57) ABSTRACT

The present disclosure relates to systems, methods, and non-transitory computer-readable media for introducing a unique team-centric encryption key that expands a cryptographic security boundary to a team (instead of to users and/or devices). In some embodiments, the disclosed systems can detect a device enrollment request to gain access to team content. associated with a team of enrolled devices. Upon receiving the enrollment request from the device, the disclosed systems can determine a device key associated with that device and a team key associated with the team and can encrypt the team key with the device key (thus generating an encrypted team key). The disclosed systems can also provide the encrypted team key to a requesting device for enrollment and/or can use the encrypted team key to encrypt and/or decrypt team data.

### BACKGROUND

In the field of end-to-end encryption, recent years have seen significant developments in key management and encryption techniques. For instance, existing encryption systems have been developed with different types of key management strategies, with some centered around user accounts and others centered around client devices. Under these approaches, cryptographic security boundaries are scoped around a singular entity—either a user account or a client device—so that the data is encrypted, either end to end or otherwise. In some cases, encryption protects data not just against a service provider or external actors but also against other participants within the same system.

Despite some benefits, conventional systems exhibit a number of deficiencies or drawbacks, particularly relating to reliability, flexibility, and efficiency. For example, although conventional systems may protect data against inadvertent and/or deliberate data breaches (including by other user accounts in a shared system), the encryption paradigms of existing systems leave them vulnerable to data loss. Because existing end-to-end encryption is limited to singular-entity keys (e.g., user account keys or client device keys) to encrypt data, loss of a key inevitably leads to complete and irretrievable data loss of all encrypted data. Conventional systems (such as those of end-to-end encrypted messaging applications for ciphertext) that use a device-centric key management are also prone to data loss, particularly in cases of device malfunction or misplacement.

In addition to unreliably risking data loss, contemporary systems are also inefficient and inflexible. While some existing systems use key escrow techniques to ameliorate certain reliability issues, conventional escrow methods are inefficient (and sometimes contribute to additional unreliability). In particular, a major challenge to adding key escrow in user-centric key management implementations involves requiring access to the user account key when creating or modifying the key escrow. Accordingly, existing systems often assign a (single) trusted party for key escrow, especially when interacting with external third-party systems without direct user interaction, such as when using a system for cross-domain identity management (SCIM) for external user management. However, not only can the trusted party also lose encryption keys (which again results in lost data), but the trusted party is not always online and/or available when keys are lost. Thus, rigidly relying on a single trusted party for key escrow often results in prolonged data loss, repeated decryption requests, and/or delayed key decryption for re-accessing lost data while waiting for the trusted party to receive and respond to decryption requests.

As another example of their inefficient, inflexible natures, existing systems often provide inefficient encryption interfaces, particularly regarding utilizing key escrow functionality. As noted above, in cases of asynchronous key management, conventional systems must often wait for a trusted party to receive and respond to escrow requests before providing a lost key. This delay can not only make the escrow process inefficient and difficult to manage (as noted above) but can also bog down user interfaces involved in key management. Indeed, existing key management interfaces for creating a new user account, adding a new client device, creating a new role, or changing a permission are often either (partially or entirely) nonfunctional or disabled during periods of waiting for responses from the trusted party in asynchronous key escrow.

These along with additional problems and issues exist with regard to conventional encryption systems.

### BRIEF SUMMARY

This disclosure describes one or more embodiments of systems, methods, and non-transitory computer-readable storage media that provide benefits and/or solve one or more of the foregoing and other problems in the art. For instance, the disclosed systems can introduce a unique team-centric encryption key that expands a cryptographic security boundary to a team (instead of to users and/or devices). By utilizing a team key that is accessible to all team members (e.g., member devices) to encrypt team data, the disclosed systems can provide a new encryption level not found in prior systems, and which affords certain benefits regarding key escrow, enrollment, and others. In some embodiments, the disclosed systems can detect a device enrollment request to gain access to team content associated with a team of enrolled devices. Upon receiving the enrollment request from the device, the disclosed systems can determine a device key associated with that device and a team key associated with the team and can encrypt the team key with the device key (thus generating an encrypted team key). The disclosed systems can also provide the encrypted team key to a requesting device for enrollment and/or can use the encrypted team key to encrypt and/or decrypt team data. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example overview of generating an encrypted team key and providing a client device access to team content by providing the encrypted team key to the client device in accordance with one or more embodiments.

FIG. 2 illustrates an example diagram of enrolling client devices onto a team of client devices by way of manual device enrollment and automatic device enrollment in accordance with one or more embodiments.

FIG. 3 illustrates an example stratified key structure in accordance with one or more embodiments.

FIG. 4 illustrates an example diagram of team-based key escrow in accordance with one or more embodiments.

FIG. 5 illustrates an example diagram of generating a new team key based on detecting a key rotation event in accordance with one or more embodiments.

FIGS. 6A-6C illustrate example user interfaces for initializing end-to-end encryption and enrollment of a client device into a team of client devices by way of automatic device enrollment or manual device enrollment in accordance with one or more embodiments.

FIG. 7 illustrates an example user interface for creating a team folder of team content that may be encrypted end-to-end in accordance with one or more embodiments.

FIG. 8 illustrates an example user interface for verifying key fingerprints in accordance with one or more embodiments.

FIG. 9 illustrates an example user interface of an administrator device adding a pending client device to end-to-end encryption and replacing a recovery key in accordance with one or more embodiments.

FIG. 10 illustrates a diagram of an example environment in which a team key encryption system can operate in accordance with one or more embodiments.

FIG. 11 illustrates an example flowchart of a series of acts for providing a client device access to team content in accordance with one or more embodiments.

FIG. 12 illustrates a block diagram of an exemplary computing device in accordance with one or more embodiments.

FIG. 13 illustrates an example environment of a networking system including the team key encryption system in accordance with one or more embodiments.

### DETAILED DESCRIPTION

This disclosure describes one or more embodiments of a team key encryption system that can introduce a unique team-centric encryption key that expands a cryptographic security boundary to a team rather than to user accounts and/or devices. The team key encryption system can encrypt and decrypt stored content items and other data for team devices (e.g., devices associated with user accounts within a team) using a unique team-level encryption key. As part of adding devices to the team, the team key encryption system can detect a client device enrollment request to gain access to team content associated with a team of enrolled client devices. Upon receiving the enrollment request from the device, the team key encryption system can, in one or more embodiments, determine a device key associated with the requesting device and a team key associated with the team. The team key encryption system can also generate an encrypted team key by encrypting the team key with the device key. The team key encryption system can further provide the encrypted team key to the requesting client device for enrollment into the team of client devices. The team key encryption system can further use the encrypted team key to encrypt and/or decrypt team content.

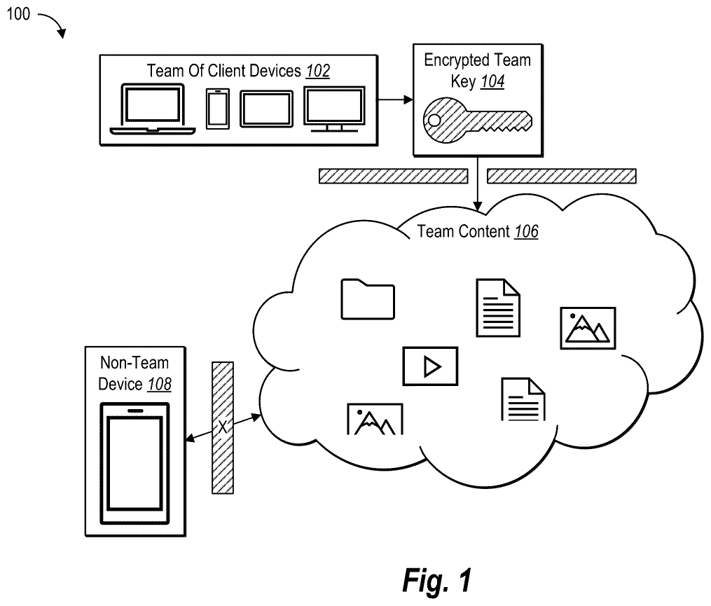

Detail regarding the team key encryption system will now be provided with reference to the figures. For example, FIG. 1 illustrates an example overview of generating an encrypted team key and providing a client device access to team content by providing the encrypted team key to the client device in accordance with one or more embodiments. Additional detail regarding the various acts and processes introduced in relation to FIG. 1 is provided thereafter with reference to subsequent figures.

As illustrated in FIG. 1, the team key encryption system 100 identifies or accesses a team 102 of client devices. For instance, the team key encryption system 100 identifies client devices associated with a content management system and which have access to shared content, such as team content 106. In various embodiments, the team 102 comprises one or more client devices, wherein the term “device” (e.g., a client device, administrator device, or a device associated with the team of client devices) can include, but is not limited to, computers, laptops, mobile devices or tablets, smartphones, web browsers, and/or and other electronic instruments as described in further detail below.

As further illustrated in FIG. 1, the team key encryption system 100 can generate an encrypted team key 104. The team key encryption system 100 can generate the encrypted team key 104 from other keys associated with devices in the team 102. For example, the team key encryption system 100 can determine one or more device keys that are associated with one or more client devices in the team 102 and can determine a team key that is associated with the team 102. Based on this determination, the team key encryption system 100 can generate the encrypted team key 104 by encrypting the team key with the one or more device keys. In one or more embodiments, the device key and the team key are part of an asymmetric encryption system, where the key pair consists of a public key and a private key. In such embodiments, the team key encryption system 100 can determine one or more public device keys that are associated with the one or more client devices and a private team key that is associated with the team 102. Based on these determinations, the team key encryption system 100 can, in the same or other embodiments, generate the encrypted team key 104 by encrypting the private team key with the one or more public device keys.

In accordance with one or more embodiments, the team key encryption system 100 employs implicit key escrow by sharing the encrypted team key 104 amongst client devices in the team 102. In particular, the team 102 can share the encrypted team key 104 amongst the client devices in the team 102 in the event one of the devices in the team 102 is lost, malfunctions, or loses the encrypted team key 104. Additional detail regarding implicit key escrow is provided below.

As shown in FIG. 1, in at least one embodiment, the team key encryption system 100 provides client devices in the team 102 with access to the team content 106 (or a portion of content within the team content 106). In particular, the team key encryption system 100 can utilize the encrypted team key 104 to decrypt the team content 106 (or a portion of content within the team content 106) so that a client device in the team 102 can cryptographically access the team content 106 (or a portion of the team content 106). In some cases, the team key encryption system 100 permits a client device in the team 102 to not only access the team content 106 but also to view, edit or modify, delete, recover, share, and/or create derivatives of the data or content contained within the team content 106 (or a portion of the team content 106).

In some embodiments, rather than giving access to all the team content 106, the team key encryption system 100 grants a device access (and/or the capability to view, edit or modify, delete, recover, share, and/or create derivatives) to a particular piece or segment of data or content contained within the team content 106. For instance, in response to a device requesting access to a particular piece or segment of data or content contained within the team content 106 (e.g., a team folder, a file, and/or a revision (e.g., a changed or revised file)), the team key encryption system 100 may provide to the requesting device, as part of a stratified key structure, a key (e.g., a namespace key, a file key, and/or a revision key) that can decrypt that particular piece or segment of data or content.

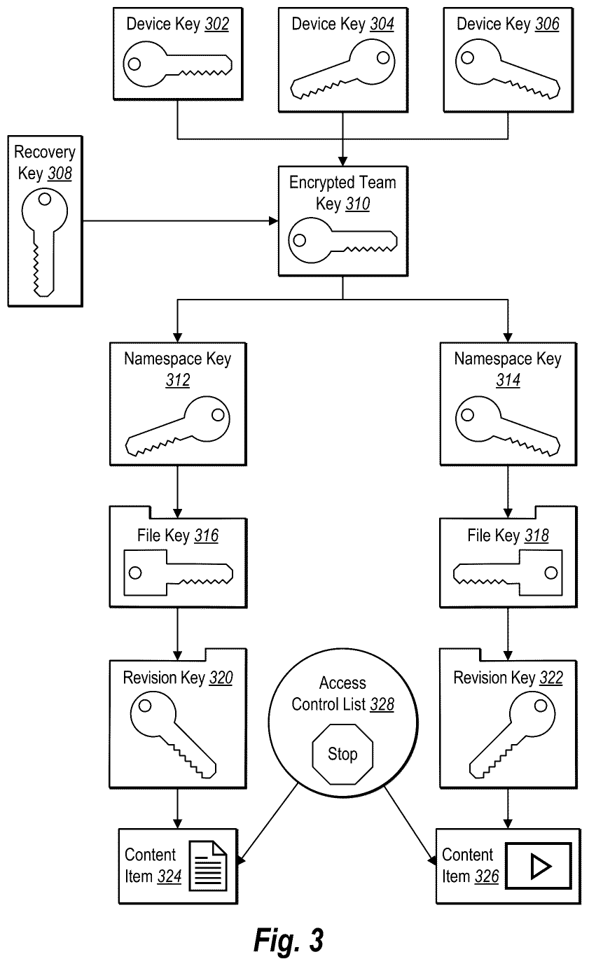

As further shown in FIG. 1, in one or more embodiments, the team key encryption system 100 denies a non-team device 108 access to (and/or capability to view, edit or modify, delete, recover, share, and/or create derivatives of) the team content 106 (or a portion of the team content 106). For instance, if the non-team device 108 is not a member of team 102 and/or does not otherwise have access to the team content 106 (or to any particular piece or segment of data or content contained within the team content 106) and/or the encrypted team key 104 (e.g., via cross-team sharing discussed in greater detail below in relation to FIG. 3), the team key encryption system 100 can deny the non-team device 108 access to (and/or capability to view, edit or modify, delete, recover, share, and/or create derivatives of) data or content associated with the team content 106.

In one or more embodiments, the team key encryption system 100 can provide several improvements or advantages over existing systems. For instance, the team key encryption system 100 can improve data reliability over prior systems. While systems that employ conventional single-account or single-device encryption afford some measure of protection against data breaches, such protections also leave data susceptible to irretrievable loss in the event of device malfunction or key loss. By contrast, the team key encryption system 100 improves reliability by introducing the concept of implicit key escrow through team keys which greatly improves data retention and reliability. For instance, the team key encryption system 100 can use a central team key associated with a team of client devices to encrypt and decrypt team data. Therefore, rather than relying on a singular entity (e.g., a user account or client device) holding the key, the team key encryption system 100 redefines an entity as a plural concept and treats an entire team as a group that can collectively hold a shared team key. Thus, in the event of key loss, device loss, or device malfunction for a single team member, the team key encryption system 100 can nevertheless retain and recover data that would be irretrievable in prior systems by propagating lost keys from other team members.

Indeed, not only does utilizing team keys provide an added layer of encryption security to protect data against external and/or internal threats, but it also drastically increases the reliability of maintaining and accessing encrypted data. By diminishing the risk that any single entity (e.g., a user account or client device) will lose its key and lead to complete and irretrievable data loss of all encrypted data, the team key encryption system 100 provides more reliable data encryption than some existing systems. Furthermore, even amongst prior systems that utilize conventional key escrow techniques, there is still a great risk that a trusted party can lose the encryption key, which, again, results in complete and irretrievable data loss of all encrypted data. The team key encryption system 100 similarly increases reliability over these prior systems by reducing the risk of data loss as a result of its implicit use of key escrow, where co-members of a team can fill in lost or missing keys for other team members.

In addition to improving reliability, embodiments of the team key encryption system 100 also improve efficiency and flexibility over prior systems. To elaborate, existing systems that employ standard key escrow techniques often experience prolonged data loss, repeated decryption requests, and/or delayed key decryption for re-accessing lost data on account of a trusted party not always being online and/or available when keys are lost. The team key encryption system 100, on the other hand, introduces and employs the notion of implicit key escrow by sharing a team key amongst client devices in a team in the event one of the team devices is lost, malfunctions, or loses the key. In one or more embodiments, so long as one or more client devices associated with the team have an active network connection and/or are otherwise online and accessible, the team key encryption system 100 can flexibly request or instruct (e.g., according to a time-based key escrow algorithm) team devices to automatically transmit the encrypted team key to the client device that lost its key. This process can be fulfilled synchronously and, by leveraging devices across an entire team, without waiting for single trusted parties who are not always online and/or available when keys are lost. Consequently, team key encryption system 100 reduces the amount of time (and the amount of data) that data is lost or inaccessible, as well as reducing the number of repeated requests for decryption and delays to key decryption for re-accessing lost data. By minimizing these factors, team key encryption system 100 greatly improves both the efficiency and flexibility of prior systems.

To expand further on the increased efficiency and flexibility, team key encryption system 100 also provides more efficient user interfaces for key management. For instance, in contrast with prior systems that frequently suffer from prolonged wait times for a trusted party receiving and responding to escrow requests (and which therefore lock or prevent access to certain interface functions in the meantime), the team key encryption system 100, as a result of its implicit key escrow approach, can provide full-function key management interfaces without such delays or partial capabilities. Indeed, by utilizing implicit key escrow, the team key encryption system 100 can bypass waiting prolonged periods of time for a trusted party to receive and respond to escrow requests and can, therefore, more efficiently and flexibly provide interfaces for performing key management functions, which include, but not limited to, creating a new user account, adding a new client device, creating a new role, or changing a permission.

As illustrated by the foregoing discussion, the present disclosure utilizes a variety of terms to describe features and advantages of the video transcript segmentation system. Additional detail is now provided regarding the meaning of such terms. As used herein, the term “encrypted team key” refers to a cryptographic key that provides and prevents cryptographic access to content on a team-specific basis. In particular, an encrypted team key can include a cryptographic key encrypted from two or more constituent keys, such as a device key of a device belonging to a team and a team key associated with the team. For instance, the team key encryption system 100 generates the encrypted team key by encrypting a team key associated with the team with a device key associated with the client device. In some instances, the team key encryption system 100 generates the encrypted team key as an asymmetric encryption key by combining a private team key with a public device key.

As used herein, the term “enroll” (and its derivatives) refers to the team key encryption system 100 providing (or having already provided) a client device with access to team content (or portion of team content) associated with a team of client devices by providing the client devices with access to a team key. As used, herein, the term “enrollment request” refers to computer instructions and/or network communications defining a request to enroll in a team (e.g., to gain access to team content with a team key). An enrollment request can be initiated, for instance, when the team key encryption system 100 receives an indication (e.g., from an administrator device associated with the team) to encrypt the team content (or a portion of the team content). Upon receiving the indication, the team key encryption system 100 can transmit a notification to the client device that the team content (or portion of the team content) will be encrypted and prompt the client device to request enrollment. Additionally, an enrollment request can also be initiated when, in one or more embodiments, the client device attempts to access (or otherwise view, edit or modify, delete, recover, share, and/or create derivatives of) the team content (or a portion of the team content). In such cases, the team key encryption system 100 can transmit a notification to the client device and prompt the client device to request enrollment.

Relatedly, as used herein, the term “automatic device enrollment” (or “automatic enrollment”) refers to a system or mode (of the team key encryption system 100) for enrolling one or more client devices to a team of client devices by, in response to detecting an enrollment request from the one or more client devices, automatically generating an encrypted team key and applying the encrypted team key to the one or more client devices (e.g., with key verification disabled). For instance, when generating the encrypted team key, automatic device enrollment can, in one or more embodiments, utilize an automatic enrollment algorithm (e.g., a time-based algorithm) that can automatically notify all (or a subset of) enrolled client (or team) devices that one or more client devices are requesting enrollment. The automatic enrollment algorithm can, in one or more embodiments, involve a time delay in requesting that one or more enrolled client (or team) devices generate the encrypted team key based on factors, such as the number of devices enrolled in the team, a probability that an enrolled device is available online, and/or detecting whether an encrypted team key has already been sent. In some embodiments, the team key encryption system 100 randomizes (e.g., randomly applies) the time delay when requesting that the one or more enrolled client (or team) devices generate the encrypted team key.

Along those lines, as used herein, the term “manual device enrollment” (or “manual enrollment”) refers to a system or mode (of the team key encryption system 100) for enrolling one or more client devices associated with a team of client devices by, in response to detecting an enrollment request from the one or more client devices, providing the enrollment request to an administrator device associated with the team, whereupon the administrator device generates an encrypted team key. In one or more embodiments, the team key encryption system 100 can cause the administrator device to determine whether a client device can be granted access to the team content by causing the administrator device to verify that device key fingerprints match (e.g., with key verification enabled). Upon causing the administrator device to determine that the device key fingerprints match, the team key encryption system 100 can cause the administrator device to generate the encrypted team key. For example, the team key encryption system 100 can cause the administrator device to encrypt the team key with the device key associated with the one or more client devices. In the same or other embodiments, manual device enrollment can include the team key encryption system 100 causing the administrator device to leverage (e.g., by causing the administrative device to enter) a recovery key to enroll the client device.

As used herein, the term “key fingerprint” refers to a shortened (e.g., hash-based), unique identifier derived from a public key that indicates or encodes a cryptographic key using a cryptographic hash function. A key fingerprint can provide a way to verify the authenticity of a cryptographic key without exposing the full key itself. The key fingerprint can, in one or more embodiments, be a string of hexadecimal digits and be shorter than the key it identifies.

As also used herein, the term “team content” (e.g., team content 106 above) refers to data or content associated with a team of client devices associated with a content management system. More specifically, team content can refer to specific content items and/or one or more digital storage locations for sharing digital content between two or more computing devices or user accounts within a team. For instance, team content can include digital storage locations in a cloud storage medium that are accessible only to client devices and/or user accounts associated with (or within a cryptographic boundary of) an encrypted team key. In some cases, team content can include a hierarchy including one or more team folders and/or team subfolders. Additionally, the hierarchy within the team content can further include one or more files and/or one or more revisions (e.g., revised or changed files) within the one or more team folders and/or team subfolders. The data or content within the team content can comprise any type of data or content associated with the team that can be stored digitally, including, but not limited to, documents, photographs, audio files, video files, or any revision thereof.

Relatedly, as used herein, the phrase “team of client devices” (or simply “team”) refers to one or more electronic devices that are collectively associated with one another as a single entity or group within a content management system. These devices can be configured to access, store, and manage team content, which is secured within a cryptographic boundary governed by an encrypted team key. In some embodiments, each client device in the team of client devices has access to the encrypted team key, and each can therefore access and/or interact with the team content. The team of client devices can be restricted to those client devices which have been enrolled into the team of client devices (e.g., via automatic device enrollment or manual device enrollment). In some cases, the team of client devices can include an administrator device. In the same or other embodiments, each “device” in the team of client devices can include, but is not limited to, computers, laptops, mobile devices or tablets, smartphones, web browsers, and/or and other electronic instruments.

Along those lines, as used herein, the term “administrator device” refers to an electronic devices—such as a computer, mobile device, tablet, or web browser—that has administrative privileges within a content management system. In some embodiments, the administrator device has elevated permissions that allow it to manage team settings, client device and user account access, and/or security configurations, including the control of encrypted keys and permissions for team content. In one or more embodiments, the administrator device can manage which client devices are associated with a team of client devices (e.g., managing which client devices can be enrolled into the team of client devices), oversee and configure access to digital storage locations (e.g., to team content), assign roles to client devices, manage hierarchical structures of team folders, and ensure compliance with security protocols across the client devices in the team of client devices.

As further used herein, the term “asymmetric encryption” (or “public-key encryption”) refers to a cryptographic method (e.g., elliptic curve cryptography (ECC)) that uses a pair of mathematically related keys: a public key and a private key. In particular, the term “public key” (or “public encryption key”) refers to a cryptographic key as part of a public-private key pair associated with a device (e.g., a client device) or a user account that is widely distributed. In some cases, a first client device uses a public key of a second client device to encrypt digital data (e.g., for access by the second client device). Conversely, the term “private key” (or “private encryption key”) refers to a cryptographic key as part of a public-private key pair associated with a client device kept or stored privately by the client device. In some cases, the client device uses the private encryption key to decrypt digital data that was encrypted utilizing a corresponding public encryption key from the public-private key pair.

Conversely, as used herein, the term “symmetric encryption” refers to a cryptographic method (e.g., advanced encryption standard (AES)) that uses a single encryption key (or a symmetric encryption key) for both the encryption and decryption of digital data. In particular, the same key can be used by both a sending device and a recipient device to ensure data confidentiality. The term “encryption key” (or “symmetric encryption key”) refers to a cryptographic key that is shared between two or more devices (e.g., client devices) or user accounts. In some cases, a first device uses a symmetric key to encrypt data, and the same key is used by a second device to decrypt the data.

As used herein, the term “key rotation event” refers to a detected action or other indicator that initiates a rotation of an encrypted team key. For example, a key rotation event can trigger a renewal or modification of an encryption key by generating a new encryption key to replace an existing encryption key. In one or more embodiments, a key rotation event includes, but is not limited to, the team key encryption system 100 detecting: (1) a change to a team of client devices associated with team content, (2) an expiration of a team key corresponding to an indication of a time threshold associated with the team content, and/or (3) a command from a device (e.g., an administrator device associated with the team of client devices) to change a shared encryption key (e.g., a manual request to rotate an encryption key, such as by an administrator device associated with the team of client devices).

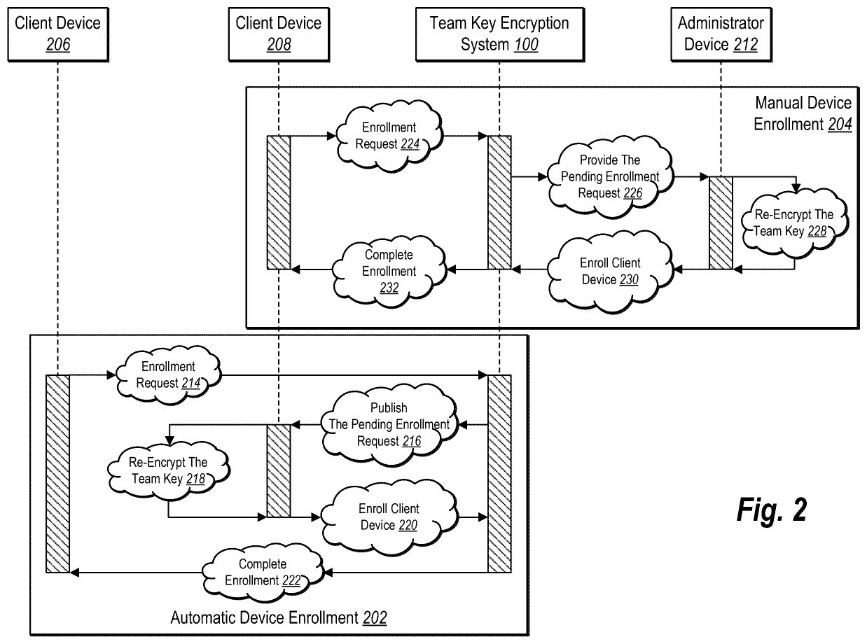

Additional detail regarding the team key encryption system 100 will again be provided with reference to the figures. For example, as mentioned above, the team key encryption system 100 can enroll a client device into a team of client devices. In particular, the team key encryption system 100 can enroll a client device into the team of client devices by, in response to an enrollment request, generating an encrypted team key and providing the encrypted team key to the client device. FIG. 2 illustrates an example diagram of enrolling client devices into the team of client devices by way of automatic device enrollment and manual device enrollment in accordance with one or more embodiments.

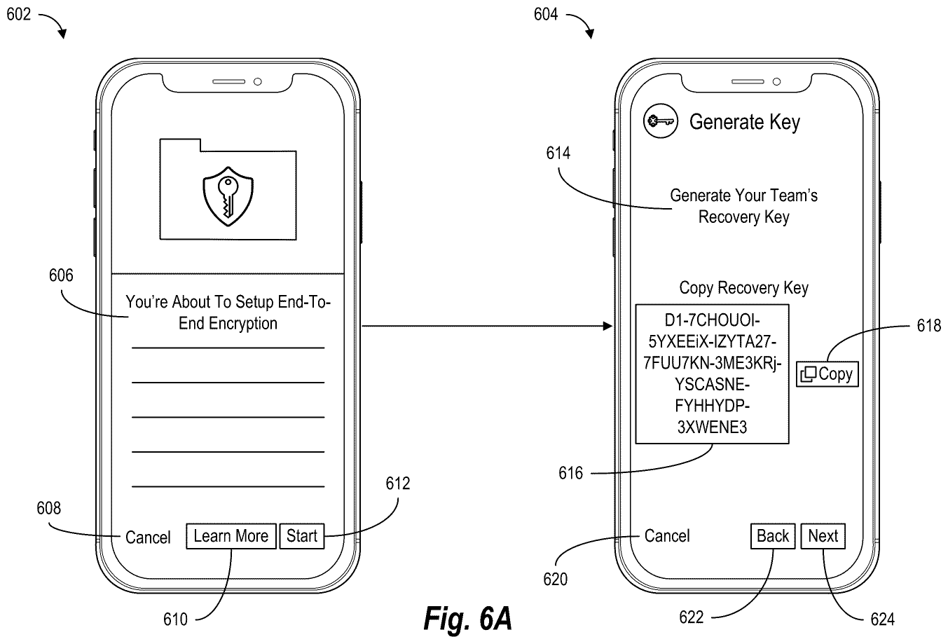

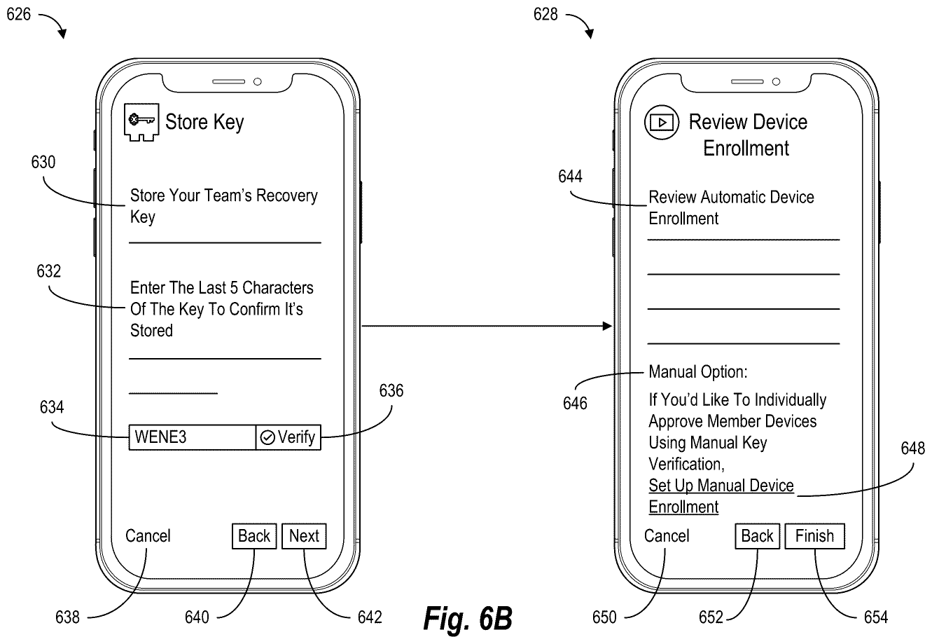

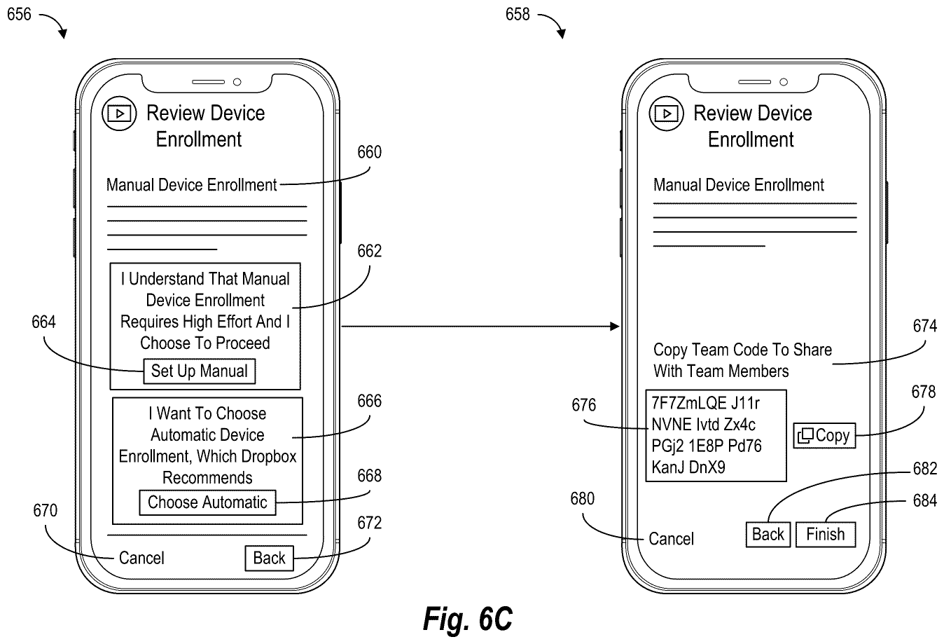

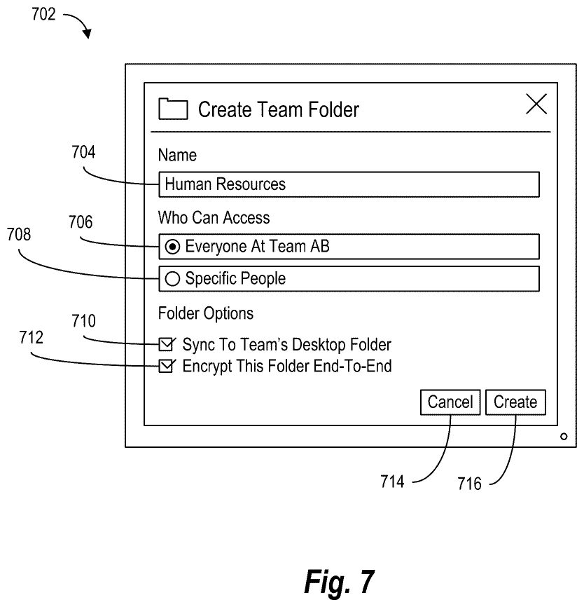

As illustrated in FIG. 2, the team key encryption system 100 can utilize automatic device enrollment 202 to enroll a client device 206 into a team of client devices associated with a content management system. Specifically, the team key encryption system 100 can provide, for display on a device (e.g., an administrator device) associated with the team, a team key management interface (e.g., a graphical user interface (GUI)) with one or more selectable elements for initiating end-to-end encryption for team content (or a portion of team content) associated with the team. In one or more embodiments, upon selection of the one or more selectable elements, the team key encryption system 100 initiates end-to-end encryption for the team content (or portion of the team content) associated with the team to generate encrypted team content. In the same or other embodiments, the team key encryption system 100 also provides, for display on the device (e.g., the administrator device 212) associated with the team, an option to enroll the client device 206 into the team via the automatic device enrollment 202. Additional detail regarding these processes can be found below in relation to FIGS. 6A-6C. Further, the team key encryption system 100 can provide, for display on the device (e.g., an administrator device) associated with the team, one or more selectable options for selecting which client devices (or user accounts) can be granted access to the encrypted team content. Additional detail regarding this process can be found below in relation to FIG. 7.

As also illustrated in FIG. 2, upon selecting the option to enroll client device 206 into the team via the automatic device enrollment 202, the team key encryption system 100 generates an enrollment request 214 for enrolling the client device 206 into the team of client devices. In particular, the team key encryption system 100 detects the enrollment request 214 in the form of a request by the client device 206 to access team content or in the form of a team device (e.g., an administrator device 212) adding the client device 206 to the team. In one or more embodiments, the team key encryption system 100 initiates the enrollment request 214 upon receiving an indication (e.g., from the administrator device 212) to encrypt the team content (or a portion of the team content).

Upon receiving the indication, the team key encryption system 100 can transmit a notification to the client device 206 that the team content (or portion of the team content) will be encrypted and can prompt the client device 206 to request enrollment. In the same or other embodiments, the team key encryption system 100 initiates the enrollment request 214 when the client device 206 attempts to access (or otherwise view, edit or modify, delete, recover, share, and/or create derivatives of) the team content (or a portion of the team content). In some instances, the team key encryption system 100 transmits a notification to the client device 206 and prompts the client device 206 to request enrollment.

Based on detecting the enrollment request 214, the team key encryption system 100, in one or more embodiments pertaining to the automatic device enrollment 202, verifies or determines whether the client device 206 can be granted access to the team content. In particular, the team key encryption system 100 determines a device key associated with the client device 206 and a team key associated with the team. In at least one embodiment, the team key encryption system 100 utilizes asymmetric encryption (or public-key encryption) and, therefore, determines a public device key associated with the client device 206 and a private team key associated with the team. In some cases, the team key encryption system 100 generates a device key for the client device 206 by using one or more key generation algorithms or key derivation functions. The team key encryption system 100 further determines the team key assigned to the team of client devices for cryptographic access to team content.

Upon determining the device key and the team key, the team key encryption system 100 performs an act 216 to publish the enrollment request. To elaborate, the team key encryption system 100 publishes the enrollment request 214 to enrolled client devices already part of the team. The team key encryption system 100 further utilizes a time-based automatic enrollment algorithm to generate an encrypted team key for enrolling the client device 206.

Indeed, as shown in FIG. 2, the team key encryption system 100 selects and causes client device 208 of the team and/or other client devices in the team to perform an act 218 to re-encrypt the team key (or generate an encrypted team key) for the client device 206. In particular, in response to publishing the enrollment request 214 (or transmitting the enrollment request 214), the team key encryption system 100 utilizes an automatic enrollment algorithm (e.g., a time-based algorithm) to request re-encryption of the team key.

To elaborate, as part of the act 218, the team key encryption system 100 utilizes an automatic enrollment algorithm to determine a number and/or a timing of team devices from the client device 208 and/or the other client devices in the team to select for generating an encrypted team key. For instance, the team key encryption system 100 utilizes the automatic enrollment algorithm to distribute the enrollment request 214 to different team devices on a periodic basis over a set interval. In some cases, the team key encryption system 100 determines the number of team devices and/or the periodicity of providing the enrollment request 214 based on a threshold probability of enrolling the client device 206.

Specifically, the team key encryption system 100 can select, from the number of team devices, at least one team device to perform the act 218 to re-encrypt the team key (or to generate an encrypted team key). By using the automatic enrollment algorithm, the team key encryption system 100 selects the at least one team device to perform the act 218, and delays selecting other team devices to perform the act 218 based on factors that include, but are not limited to, the number of devices enrolled in the team, a probability that an enrolled device is available online, and/or detecting whether an encrypted team key has already been re-encrypted (or generated) and transmitted.

In some cases, the team key encryption system 100 selects a number or a proportion of enrolled team devices to process the enrollment request 214 to generate an encrypted team key. Depending on the timing (e.g., time of day and/or day of week) of the enrollment request 214, not all team devices are likely to be online and accessible to perform the act 218. To achieve at least a threshold probability of enrollment, the team key encryption system 100 thus provides the enrollment request 214 (and/or encryption instructions) to an initial number or an initial proportion of team devices. If the team key encryption system 100 determines or detects that none of the team devices generate an encrypted team key after a certain time interval, the team key encryption system 100 selects a subsequent subset (having a number or a proportion) to perform the act 218. Indeed, the team key encryption system 100 can select the at least one team device according to a time delay that offsets respective requests to the number of team devices for performing the act 218. To elaborate, the team key encryption system 100 offsets respective requests (e.g., by not sending all requests at one time) to avoid an inefficient and unnecessary number of team devices from all simultaneously attempting to perform the act 218. In some embodiments, the team key encryption system 100 randomizes (randomly applies) the time delay when selecting the at least one team device. The team key encryption system 100 can repeat the time delay process of periodically providing the enrollment request 214 to team devices until detecting generation of (or receiving) an encrypted team key.

In at least one embodiment, the team key encryption system 100 selects and/or causes the client device 208 and/or the other client devices in the team to perform the act 218 using a synchronous approach. In particular, so long as at least one of the client device 208 and/or the other client devices in the team has an active network connection and/or is otherwise online and accessible, the team key encryption system 100 can synchronously and flexibly select and/or cause (e.g., according to the automatic enrollment algorithm discussed above) the at least one of the client device 208 and/or the other client devices in the team to automatically perform the act 218. Indeed, the team key encryption system 100 can detect accessibility of a team device and can thus provide the enrollment request 214 to the accessible team device for synchronous generation of an encrypted team key.

In the same or other embodiments, the team key encryption system 100 can detect or determine that the client device 208 and/or the other client devices in the team do not have an active network connection and/or are not otherwise online and accessible. Accordingly, the team key encryption system 100 can select and/or cause the client device 208 and/or the other client devices in the team to perform the act 218 asynchronously. For example, if the client device 208 and/or the other client devices in the team do not have an active network connection and/or are not otherwise online and accessible, the team key encryption system 100 can delay selecting and/or causing the client device 208 and/or the other client devices in the team to perform the act 218 until at least one of the client device 208 and/or the other client devices in the team has an active network connection and/or is otherwise online and accessible. In some embodiments, the team key encryption system 100 can provide the enrollment request 214 to a data buffer or a request queue that automatically triggers providing the enrollment request 214 to the next active/accessible team device upon detection.

Continuing the description automatic device enrollment 202, in some embodiments, the team key encryption system 100 performs an act 220 to enroll the client device 206. For instance, the team key encryption system 100 performs the act 220 by adding the client device to the team of devices, thereby granting access to team content. In at least one embodiment, the team key encryption system 100 processes and stores the re-encrypted team key. In some cases, the team key encryption system 100 further propagates the new encrypted team key to other team devices (e.g., the client device 208 and/or the other client devices in the team). In certain embodiments, the team key encryption system 100 performs an act 222 to complete enrollment for the client device 206 by providing the encrypted team key to the client device 206, along with an enrollment notification.

As additionally illustrated in FIG. 2, the team key encryption system 100 can utilize manual device enrollment 204 to enroll a client device 208 into a team of client devices associated with a content management system. Specifically, the team key encryption system 100 can receive a selection for the manual device enrollment 204 from the team key management interface of the device (e.g., the administrator device 212) associated with the team.

As further illustrated in FIG. 2, upon receiving the selection for the option to enroll the client device 208 into the team via the manual device enrollment 204, the team key encryption system 100 can implement a manual enrollment mode. Thus, in response to detecting, from the client device 208, an enrollment request 224 to gain access to the encrypted team content (or a portion of the encrypted team content) in the form of a request to join the team and/or access encrypted team content. In the same or other embodiments, the team key encryption system 100 initiates or generates the enrollment request 224 in response to detecting the client device 208 attempting to access (or otherwise view, edit or modify, delete, recover, share, and/or create derivatives of) the team content (or a portion of the team content). In such cases, the team key encryption system 100 can transmit a notification to the client device 208 and prompt the client device 208 to request enrollment.

In one or more embodiments, the team key encryption system 100 performs an act 226 to provide the enrollment request 224 to an administrator device 212 associated with the team. Indeed, for manual device enrollment 204, the team key encryption system 100 provides the enrollment request 224 to the administrator device 212 for approval and encryption of an encrypted team key to enroll the client device 208.

As part of the encryption process, the team key encryption system 100 performs, or causes the administrator device 212 to perform, an act 228 to re-encrypt the team key (or to generate an encrypted team key) associated with the team. For example, the team key encryption system 100 detects and transmits a device key associated with client device 208 to the administrator device 212. In particular, the team key encryption system 100 determines a device key associated with the client device 208 and a team key associated with the team. In at least one embodiment, the team key encryption system 100 utilizes asymmetric encryption (or public-key encryption) and, therefore, determines a public device key associated with the client device 208 and a private team key associated with the team.

As part of the act 228, the administrator device 212 re-encrypts the team key (or generates the encrypted team key) in accordance with one or more embodiments. In particular, based on performing the act 226, the team key encryption system 100 can cause the administrator device 212 to verify (or determine) whether the client device 206 can be granted access to the team content. For example, the team key encryption system 100 can transmit a device key fingerprint from the client device 208 to the administrator device 212. In some cases, the team key encryption system 100 causes the administrator device 212 to calculate the fingerprint of the received device key and compare that calculated fingerprint with the device key fingerprint received from the client device 208 to verify that the device key fingerprints match. In the same or additional embodiments, upon causing the administrator device 212 to verify that the device key fingerprints match, the team key encryption system 100 causes the administrator device 212 to perform the act 228 by encrypting the team key with the device key. In some instances, the team key encryption system 100 causes the administrator device 212 to leverage (e.g., by causing the administrative device 212 to enter) a recovery key to perform the act 228. Additional detail regarding recovery keys is provided below.

As further shown in FIG. 2, in at least some embodiments, the team key encryption system 100 performs an act 230 to enroll the client device 208. For instance, the team key encryption system 100 receives (or causes the administrator device 212 to provide) enrollment information for the client device 208. Specifically, the team key encryption system 100 receives the encrypted team key. In at least one embodiment, the team key encryption system 100 processes and stores the encrypted team key to enroll for the client device 208. In some cases, the team key encryption system 100 propagates the newly encrypted team key to other team devices as well.

Additionally, the team key encryption system 100 performs an act 232 to complete enrollment. The team key encryption system 100 completes enrollment by providing the re-encrypted team key (or the encrypted team key) to the client device 206, along with a notification of enrollment to the team of devices.

As expressed above, in some embodiments, the team key encryption system 100 provides encryption keys as part of a stratified key structure for multi-level encryption at various cryptographic boundaries. In particular, the team key encryption system 100 generates a new key structure that includes team keys in addition to device keys, namespace keys, and others. FIG. 3 illustrates an example stratified key structure in accordance with one or more embodiments.

As illustrated in FIG. 3, in one or more embodiments, the team key encryption system 100 generates a stratified key structure. Specifically, the team key encryption system 100 can generate encryption keys comprising symmetric encryption keys and asymmetric encryption keys at respective levels within the stratified key structure. For example, the team key encryption system generates one or more team keys associated with a team of client devices, one or more device keys (or client device keys) one or more namespace keys associated with a team folder (and/or subfolder) within team content, one or more file keys associated with a file in a team folder (and/or subfolder), and/or one or more revision keys associated with a change (or revision) to a file in a team folder (and/or a team subfolder) at respective levels within the stratified key structure.

As further illustrated in FIG. 3, the team key encryption system 100 can generate an encrypted team key 310 by combining the one or more device keys (e.g., a device key 302, a device key 304, and/or a device key 306) with a team key. In particular, the team key encryption system 100 can generate the encrypted team key 310 as an asymmetric encryption key by combining a public device key with a private team key. As an example, the team key encryption system 100 combines one or more of the device key 302, the device key 304, and/or the device key 306 with the team key to generate the encrypted team key 310. In alternative embodiments, upon generating the encrypted team key 310 with the one or more device keys (e.g., the device key 302, the device key 304, and/or the device key 306), the team key encryption system 100, as explained above, can re-encrypt the encrypted team key 310 with one or more other device keys corresponding to one or more client devices requesting enrollment into the team. As an example, upon the device key 302 and the device key 304 combining with the team key to generate the encrypted team key 310, the team key encryption system 100 can re-encrypt the encrypted the team key 310 to include the device key 306.

As shown in FIG. 3, the team key encryption system 100 generates, in one or more embodiments, a recovery key 308 (or a backup key) as part of the stratified key structure. In particular, the team key encryption system 100 can generate the recovery key 308 as an asymmetric encryption key and can provide it to a device (e.g., an administrator device) associated with the team for storage (e.g., digital storage (such as in a password manager) or physical storage). In the same or other embodiments, the team key encryption system 100 generates multiple recovery keys and provides each key to different devices and/or client devices. In at least one embodiment, the recovery key 308 is associated with the encrypted team key 310 and provides access to (or recovery of) the encrypted team key 310. In the same or other embodiments, the team key encryption system 100 causes the device (e.g., the administrator device) to provide the recovery key 308 to access (or regain access to) the encrypted team key 310 if one or more client devices of the team do not have an active network connection; are not online and accessible; and/or have been lost, malfunctioned, or lost the encrypted team key 310. In at least one embodiment, the team key encryption system 100 causes the device (e.g., the administrator device) to enter a recovery key to re-encrypt a team key (or generate an encrypted team key).

As also shown in FIG. 3, in accordance with one or more embodiments, the team key encryption system 100 generates a set of additional encryption keys as part of the stratified key structure (e.g., in addition to the encrypted team key 310 and the one or more device keys). For example, the team key encryption system 100 generates one or more namespace keys, one or more file keys, and one or more revision keys.

The team key encryption system 100 generates one or more namespace keys (e.g., namespace key 312 and/or namespace key 314) associated with one or more corresponding team folders and/or team subfolders in the team content. For instance, the namespace key 312 can be associated with a directory or a namespace, such as team folder A, while the namespace key 314 can be associated with a team folder B. Accordingly, in this example, the namespace key 312 can cryptographically safeguard team folder A (and its contents) from being accessed (or otherwise viewed, edited or modified, shared, created, and the like) by devices (or users) without the namespace key 312, while the namespace key 314 can cryptographically safeguard team folder B in like fashion using the namespace key 314. In some cases, the team key encryption system 100 generates the one or more namespace keys (e.g., the namespace key 312 and the namespace key 314) as asymmetric encryption keys by using the encrypted team key 310 to encrypt each of the one or namespace keys.

As illustrated in FIG. 3, in one or more embodiments, the team key encryption system 100 generates one or more file keys (e.g., a file key 316 and a file key 318) as part of the stratified key structure. In particular, the team key encryption system 100 generates file keys for files in one or more folders (e.g., team folders). As an example, the file key 316 can be associated with a file contained within the folder A, while the file key 318 can be associated with a file contained within the folder B.

Accordingly, in this example, the file key 316 can cryptographically safeguard one file (or other block of data) and/or its derivatives from being accessed (or otherwise viewed, edited or modified, shared, created, or the like) by devices (or users) without the file key 316, while the file key 318 can cryptographically safeguard another file and/or its derivatives in like fashion. Further, in the same or other embodiments, the team key encryption system 100 generates the one or more file keys as symmetric encryption keys by using one or more namespace keys (e.g., the namespace key 312 and/or the namespace key 314) to encrypt each of the one or more file keys. For instance, the team key encryption system 100 can encrypt the file key 316 for the file A by using the namespace key 312, and/or the team key encryption system 100 can encrypt the file key 318 for the file B using the namespace key 314.

As also illustrated in FIG. 3, in one or more embodiments, the team key encryption system 100 generates one or more revision keys (e.g., a revision key 320 and/or a revision key 322) as part of the stratified key structure. In particular, the team key encryption system 100 generates a revision key associated with a change (or revision) to a file in a folder (e.g., a team folder). Specifically, each version of a file can have a unique revision key resulting from a modification made to the contents (or metadata) of the file. As an example, the revision key 320 can be associated with a change (or revision) to one file contained within folder A, while the revision key 322 can be associated with a change (or revision) to another file contained within folder B.

Accordingly, in this example, the revision key 320 can cryptographically safeguard the newly modified version of the first file and/or its derivatives from being accessed (or otherwise viewed, edited or modified, shared, created, or the like) by devices (or users) without the revision key 320, while the revision key 322 can cryptographically safeguard the revised version of the second file in like fashion. In the same or other embodiments, the team key encryption system 100 generates the one or more revision keys as symmetric encryption keys by using one or more file keys (e.g., the file key 316 and/or the file key 318) to encrypt each of the one or more revision keys. For instance, the team key encryption system 100 can encrypt the revision key 320 for the file A (or for a change to the file A) by using the file key 316, and/or the team key encryption system 100 can encrypt the revision key 322 for the file B (or for a change to the file B) using the file key 318.

As shown in FIG. 3, the team key encryption system 100 can encrypt file content(s) and/or changed (or revised) file content(s) by using the one or more revision keys. For instance, the team key encryption system 100 can encrypt a version of content item 324 generated based on a change (or revision) using the revision key 320. The team key encryption system 100 can also encrypt content item 326 based on a change (or revision) by using the revision key 322. As used herein, the term “content item” can refer to a digital object or a digital file that includes information interpretable by a computing device (e.g., a client device) to present information to a user. A content item can include a file or a folder such as a digital text file, a digital image file, a digital audio file, a webpage, a website, a digital video file, a web file, a link, a digital document file, or some other type of file or digital object. A content item can have a particular file type or file format, which may differ for different types of content items (e.g., digital documents, digital images, digital videos, or digital audio files). In some cases, a content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A content item can be editable or otherwise modifiable and can also be sharable from one user account (or client device) to another. In some cases, a content item is modifiable by multiple user accounts (or client devices) simultaneously and/or at different times.

As further shown in FIG. 3, in at least one embodiment, the team key encryption system 100 can utilize Access Control Lists (ACLs) 328 to manage and protect access to the data or content contained within the team content (or a portion of the team content). For example, the team key encryption system 100 can utilize ACLs 328 to manage and protect access to (and/or viewing, editing or modifying, deleting, recovering, sharing, and/or creating derivatives of) a folder or subfolder, a file, a change (or revision) to a file, and/or to a content item (e.g., content item 324 and/or content item 326). In particular, by utilizing the ACLs 328, the team key encryption system 100 can determine which client devices, users, and/or system processes have permission to access (and/or to view, edit or modify, delete, recover, share, and/or create derivatives of) the data or content contained within the team content (or a portion of the team content). As an example, if a client device (or a user) leaves the team, the ACLs 328 can limit or revoke that ability of the client device (or the user) to access (and/or otherwise view, edit or modify, delete, recover, share, and/or create derivatives of) the team content.

In some embodiments, the team key encryption system 100 bypasses (or uses a key structure omitting) one or more levels or keys in the stratified key structure when encrypting keys. For example, by bypassing or omitting the namespace key level in the stratified key structure, the team key encryption system 100 can use the team key to encrypt each of the file keys. As another example, the team key encryption system 100 can bypass the file key level in the stratified key structure and use the namespace keys to encrypt each of the revision keys. Additionally, while FIG. 3 illustrates namespace keys and file keys, these keys can cover encryption keys for other types or structures of data. For instance, a namespace key can by synonymous or interchangeable with a domain key or a folder key. As another example, a file key can be interchangeable with a data block key or content item key that encrypts data for a particular content item or other data block (e.g., a subcomponent of a file or discrete segment of data).

In one or more embodiments, the team key encryption system 100 can share the team content with one or more other teams (e.g., cross-team sharing). In particular, the team key encryption system 100 can share the one or more namespace keys (e.g., the namespace key 312 and/or the namespace key 314), the one or more file keys (e.g., the file key 316 and/or the file key 318), and/or the one or more revision keys (e.g., the revision key 320 and/or the revision key 322) with the one or more other teams to give the one or more other teams access to corresponding encrypted team content. For example, the team key encryption system 100 can share the one or more namespace keys, the one or more file keys, and/or the one or more revision keys with the one or more other teams by encrypting the one or more (private) namespace keys, the one or more (private) file keys, and/or the one or more (private) revision keys with one or more (public) team keys associated with the one or more other teams. As another example, the team key encryption system 100 can share the one or more namespace keys, the one or more file keys, and/or the one or more revision keys with the one or more other teams by encrypting the one or more (private) namespace keys, the one or more (private) file keys, and/or the one or more (private) revision keys with one or more (public) link keys (e.g., derived from one or more passwords) shared to (or by) the one or more other teams.

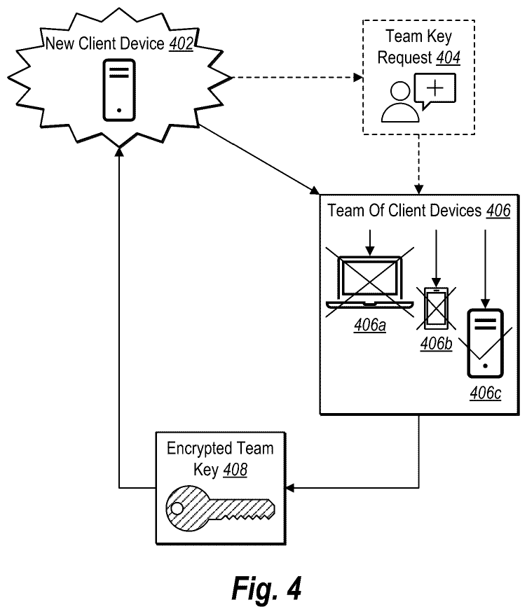

As mentioned above, the team key encryption system 100 can employ implicit key escrow by sharing an encrypted team key amongst client devices in a team of client devices. In particular, the team key encryption system 100 can share the encrypted team key amongst the client devices in the team in the event one of the devices in the team is lost, malfunctions, or loses the encrypted team key. FIG. 4 illustrates an example diagram of implicit team escrow in accordance with one or more embodiments.

As illustrated in FIG. 4, in one or more embodiments, the team key encryption system 100 manages and shares (e.g., cryptographically provides) an encrypted team key 408 amongst enrolled client devices associated with a team 406 of client devices. In addition, the team key encryption system 100 can detect a new client device 402. In particular, the team key encryption system 100 can detect the new client device 402 in instances where a new client device, that does not have access to the encrypted team key 408, comes online and/or requests to join the team 406. As an example, the new client device 402 requests to join the team 406 through a direct request, by attempting to access (or otherwise view, edit or modify, delete, recover, share, and/or create derivatives of) team content (or a portion of the team content), and/or upon a team device (e.g., an administrator device) adding the new client device 402 to the team 406.

As another example, the new client device 402 may be associated with a particular user account that is (or was) associated with the team 406 by way of another enrolled client device. To elaborate, in some embodiments, the team key encryption system 100 identifies that an enrolled client device associated with the user account is (or was) a part of the team 406. In the same or other embodiments, the team key encryption system 100 detects the new client device 402 by detecting when the new client device 402 comes online and/or attempts to access the team content and identifying that the new client device is associated with the user account. The user account may introduce the new client device 402 for several reasons, such as to replace the user account's enrolled client device in the team 406 (e.g., based on losing, damaging, or upgrading the enrolled client device) or to add another client device to the team 406 in addition to the enrolled client device.

As also illustrated in FIG. 4, in at least one embodiment, the team key encryption system 100 receives a team key request 404 from the new client device 402. In some cases, the team key encryption system 100 can further receive a verification of the team key request 404 by, for example, receiving an indication (e.g., from an administrator device) to add the new client device to a team of client devices 406. Upon receiving the indication, the team key encryption system 100 can transmit a notification to the new client device 402 that team content (or portion of the team content) is encrypted and can prompt the new client device 402 to request the team key. In the same or other embodiments, the team key encryption system 100 can initiate the team key request 404 when the new client device 402 attempts to access (or otherwise view, edit or modify, delete, recover, share, and/or create derivatives of) the team content (or a portion of the team content). In such cases, the team key encryption system 100 transmits a notification to the new client device 402 and prompts the new client device 402 to request the team key.

As further illustrated in FIG. 4, upon detecting the new client device 402, the team key encryption system 100 can select and instruct one or more other client devices associated with the team 406 to transmit the encrypted team key 408 to the new client device 402. In one or more embodiments, the one or more other client devices associated with the team 406 can include one or more client devices that have already been enrolled into the team 406 and/or an administrator device associated with the team 406. In some cases, the team key encryption system can select and instruct the one or more other client devices associated with the team 406 to transmit the encrypted team key 408 to the new client device 402 without performing the act 404.

In at least one embodiment, the team key encryption system 100 utilizes a time-based algorithm (e.g., an escrow algorithm similar to, or the same as, the automatic enrollment algorithm) to perform implicit key escrow. In particular, the team key encryption system 100 determines a number and/or timing of team devices within the one or more other client devices associated with the team 406 to select for generating the encrypted team key 408. For example, the team key encryption system 100 utilizes the time-based algorithm (e.g., the escrow algorithm) to distribute a request to transmit the encrypted team key 408 to the new client device 402 to different team devices on a periodic basis over a set interval. In some instances, the team key encryption system 100 determines the number of team devices and/or the periodicity of providing the request to transmit the encrypted team key 408 based on a threshold probability of transmitting the encrypted team key 408 to the new client device 402.

Specifically, the team key encryption system 100 can select, from the number of team devices, at least one team device to transmit the encrypted team key 408 to the new client device 402. By using the time-based algorithm, the team key encryption system 100 selects the at least one team device to transmit the encrypted team key 408, and delays selecting other team devices to transmit the encrypted team key 408 based on factors that include, but are not limited to, the number of devices enrolled in the team, a probability that an enrolled device is available online, and/or detecting whether the encrypted team key 408 has already been transmitted to the new client device 402.

In some cases, the team key encryption system 100 selects a number or a proportion of enrolled team devices to process the request to transmit the encrypted team key 408. Depending on the timing (e.g., time of day and/or day of week) of the request, not all team devices are likely to be online and accessible to transmit the encrypted team key 408 to the new client device 402. To achieve at least a threshold probability of transmitting the encrypted team key 408, the team key encryption system 100 thus provides the request to transmit the encrypted team key 408 (and/or transmitting instructions) to an initial number or an initial proportion of team devices. If the team key encryption system 100 determines or detects that none of the team devices transmit the encrypted team key 408 after a certain time interval, the team key encryption system 100 selects a subsequent subset (having a number or a proportion) to transmit the encrypted team key 408 to the new client device 402. Indeed, the team key encryption system 100 can select the at least one team device according to a time delay that offsets (or delays or postpones at intervals) respective requests to the number of team devices for transmitting the encrypted team key 408. To elaborate, the team key encryption system 100 offsets respective requests (e.g., by not sending all requests at one time) to avoid an inefficient and unnecessary number of team devices from all simultaneously attempting to transmit the encrypted team key 408 to the new client device 402. In some embodiments, the team key encryption system 100 randomizes (randomly applies) the time delay when selecting the at least one team device. The team key encryption system 100 can repeat the time delay process of periodically providing the request to transmit the encrypted team key 408 to team devices until detecting that the encrypted team key 408 has been transmitted to the new client device 402.

For example, as illustrated in FIG. 4, the team 406 can be comprised of three team devices (e.g., team devices 406a, 406b, and 406c). Continuing the example, the team key encryption system 100 can, from the three team devices, select the team device 406c to transmit the encrypted team key 408 to the new client device 402, and delay causing the team devices 406a and 406b to transmit the encrypted team key 408. Upon selecting the at least one team device, the team key encryption system 100 causes the at least one team device to transmit the encrypted team key 408 to the new client device 402.

In at least one embodiment, the process of the team key encryption system 100 selecting and/or instructing the one or more other client devices associated with the team 406 to transmit the encrypted team key 408 to the new client device 402 can be fulfilled synchronously. In particular, so long as at least one of the one or more other client devices has an active network connection and/or is otherwise online and accessible, the team key encryption system 100 can synchronously and flexibly select and/or cause (e.g., according to the time-based algorithm discussed above) the at least one of the one or more other client devices to automatically transmit the encrypted team key 408 to the new client device 402. In the same or other embodiments, if none of the one or more other client devices has an active network connection and/or is otherwise online and accessible, the team key encryption system 100 can select and/or cause the at least one of the one or more other client device to transmit the encrypted team key 408 asynchronously. For example, if none of the one or more client devices has an active network connection and/or is otherwise online and accessible, the team key encryption system 100 can delay selecting and/or causing the one or more other client devices to transmit the encrypted team key 408 until at least one of the one or more other client devices has an active network connection and/or is otherwise online and accessible.

As stated above, in one or more embodiments, the one or more other client devices associated with the team 406 can include an administrator device. For example, in situations where the team key encryption system 100 has initiated the team key request 404 and/or when no other client device is enrolled, the team key encryption system 100 can cause the administrator device to serve as the at least one team device. As another example, the team key encryption system can also cause the administrator device to serve the at least one team device when no client device of the one or more other client devices has an active network connection and/or is otherwise online and accessible. For instance, the team key encryption system 100 can cause the administrator device to provide a recovery key to access (or regain access to) the encrypted team key if one or more of the one or more other client devices do not have an active network connection; are not otherwise online and accessible; and/or have been lost, malfunctioned, or lost the encrypted team key.

In the same or other embodiments, the team key encryption system 100 initiates a team key request 404 and/or selects and instructs one or more other client devices associated with the team 406 to transmit the encrypted team key 408 to an enrolled client device upon detecting a loss of the encrypted team key from the enrolled client device. For instance, the team key encryption system 100 detects the loss of the encrypted team key 408 when the enrolled client device has lost the encrypted team key 408 (or the ability to use the encrypted team key 408), such as when the enrolled client device is lost (and an associated user account provides a notification of device loss using another device), malfunctions, experiences hardware failure (e.g., storage failure), experiences memory corruption, experiences software corruption or errors (e.g., file corruption, operating system error or crash, and/or application error or crash), experiences encryption key management issues (e.g., key erasure or wipe), experiences a user or an administrative error (e.g., accidental deletion and/or loss of password or passphrase), undergoes an inadequate backup, experiences physical tampering or theft, and/or suffers from malware or a cyber-attack.

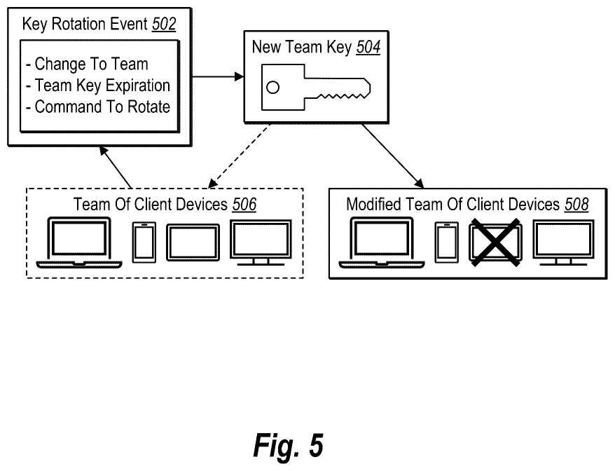

As mentioned above, the team key encryption system 100 can generate a new team key based on detecting a key rotation event. In particular, the team key encryption system 100 can detect a key rotation event and, upon detecting the key rotation event, rotate the team key by generating a new team key and replacing the team key with the new team key. FIG. 5 illustrates an example diagram of generating a new team key based on detecting a key rotation event in accordance with one or more embodiments.

As illustrated in FIG. 5, the team key encryption system 100 detects, in one or more embodiments, a key rotation event 502. In particular, the key rotation event 502 can include, but is not limited to, the team key encryption system 100 detecting: (1) a change to a team 506 of client devices associated with team content, (2) an expiration of a team key, and/or (3) a command from a device associated with the team to change a shared encryption key (e.g., a manual request to rotate an encryption key). The team key encryption system 100 may detect still other key rotation events, such as if an enrolled client device (e.g., having the team key) is lost or otherwise compromised.

As just mentioned, the team key encryption system 100 can detect a change to the team 506. Specifically, the team key encryption system 100 can detect when a client device (or a user account) joins (or is added to) the team 506 and/or leaves (or is removed from) the team 506. In some cases, based on a client device (or a user account) leaving (or being removed from) the team 506, the team key encryption system can delete (or otherwise bar access to) all keys associated with that client device (or that user account).

As also stated above, the team key encryption system 100 can detect the expiration of a team key. For instance, in one or more embodiments, the team key encryption system 100 detects that a team key as expired based on an indication of reaching a time threshold associated with the team content. As an example, the time threshold can include, but is not limited to, a specific date or a number of days, months, or years.

As further mentioned above, the team key encryption system 100 can also detect a command from a device associated with the team to change a shared encryption key. For example, the team key encryption system 100 can detect the command to change a shared encryption key from an administrator device associated with the team 506 via the selection of one or more selectable elements on a graphical user interface of the administrator device.

As further illustrated in FIG. 5, the team key encryption system 100 can, based on detecting the key rotation event 502, generate a new team key 504 for the team 506 or for a modified team 508 of client devices. To illustrate, the team key encryption system 100 generates the new team key 504 for the team 506 upon the expiration of the team key or the command from a device (e.g., an administrator device) associated with the team to change the team key. By way of another illustration, the team key encryption system 100 generates the new team key 504 for the modified team 508 upon detecting the change to the team 506.

In at least one embodiment, upon generating the new team key 504 for the team 506, the team key encryption system 100 replaces the team key with the new team key 504 for the team 506. Similarly, in the same or other embodiments, upon generating the new team key 504 for the modified team 508, the team key encryption system 100 replaces the team key with the new team key for the modified team 508. Upon replacing the team key with the new team key 504 for the team 506 or for the modified team 508, in some cases, the team key encryption system 100 generates a new encrypted team key for the team 506 or for the modified team 508 by encrypting the new team key 504 with one or more device keys associated with one or more client devices that are associated with the team 506 or the modified team 508.

In one or more embodiment, upon generating a new team key 504 and/or upon replacing the team key with the new team key 504, the team key encryption system 100 generates one or more new namespace keys, one or more new file keys, and/or one or more new revision keys. In particular, the team key encryption system 100 can generate the one or more new namespace keys and encrypt the one or more new namespace keys using the new team key 504. In the same or other embodiments, upon generating a new team key 504 and/or upon replacing the team key with the new team key 504, the team key encryption system 100 generates the one or more new file keys and encrypts the one or more new file keys using the one or more namespace keys. In at least one embodiment, the team key encryption system 100 generates the one or more new revision keys and encrypts the one or more new revision keys using the one or more new file keys. In some embodiments, the team key encryption system 100 encrypts file content(s) and/or changed (or revised) file content(s) using the one or more new revision keys.

In some cases, the team key encryption system 100 can encrypt the one or more new namespace keys, the one or more new file keys, and/or the one or more new revision keys with one or more team keys associated with one or more other teams that have (or previously had been) granted access to the team content via cross-team sharing. In some embodiments, the team key encryption system 100 may not require the one or more other teams to rotate their keys based on the team key encryption system 100 encrypting the one or more new namespace keys, the one or more new file keys, and/or the one or more new revision keys with the one or more team keys associated with the one or more other teams.

In at least one embodiment, the team key encryption system 100 encrypts new content in the team content with the new team key 504 (and/or the one or more new namespace keys, the one or more new file keys, and/or the one or more new revision keys). In some cases, the team key encryption system 100 may (or may not) re-encrypt existing content (or content existing prior to replacing the team key with the new team key 504) with the new team key 504 (and/or the one or more new namespace keys, the one or more new file keys, and/or the one or more new revision keys).

In one or more embodiments, a key rotation process (as described above in relation to FIG. 5) can be a manual process that involves interaction by an administrator device. In particular, based on detecting the key rotation event 502, the team key encryption system 100 can provide, for display on a graphical user interface (GUI) of the device (e.g., the administrator device), one or more selectable elements for generating the new team key 504 and replacing the team key with the new team key 504. In some cases, based on selecting the one or more selectable elements, the team key encryption system 100 performs the key rotation process.

In additional or alternative embodiments, the key rotation process can be an automatic process that does not involve interaction at a device. For example, based on detecting the key rotation event 502, the team key encryption system 100 can generate the new team key 504 and replace the team key with the new team key 504 automatically, without requiring the selecting of the one or more selectable elements on the GUI of the device (e.g., the administrator device).

In one or more embodiments, upon performing the key rotation process, there may be a fingerprint mismatch between key fingerprints. In particular, the team key encryption system 100 can detect that team key fingerprints do not match following the key rotation process. In such a case, the team key encryption system 100 may require a client device to newly approve the team key.

As mentioned above, the team key encryption system 100 can utilize automatic device enrollment or manual device enrollment to enroll a client device into a team of client devices associated with a content management system. In particular, the team key encryption system 100 can provide, for display on a device (e.g., an administrator device) associated with the team, a graphical user interface with one or more selectable elements for initializing end-to-end encryption and client device enrollment into the team via automatic device enrollment and/or manual device enrollment. FIGS. 6A-6C illustrate an example user interface for initializing end-to-end encryption and enrollment of a client device into a team of client devices by way of automatic device enrollment or manual device enrollment in accordance with one or more embodiments.

As illustrated in FIG. 6A, the team key encryption system 100 can provide, for display on a device (e.g., an administrator device) associated with a team of client devices, a team key management interface 602 (e.g., a graphical user interface (GUI)) with one or more selectable elements for initializing (or setting up) end-to-end encryption. In particular, the team key encryption system 100 can provide, for display on the device via the team key management interface 602, a notification 606 that can state that end-to-end encryption is about to be setup or initiated. For example, the notification 606 can read, “You're about to setup end-to-end encryption.” In one or more embodiments, the team key encryption system 100 provides one or more selectable elements for display on the device via the team key management interface 602. The one or more selectable elements can include, but are not limited to, a selectable element 608 for canceling an end-to-end encryption setup (or initialization), a selectable element 610 for learning more about the end-to-end encryption setup (or initialization), and/or a selectable element 612 for starting (or initializing) the end-to-end encryption setup (or initialization).

As also illustrated in FIG. 6A, based on selecting the selectable element 612, the team key encryption system 100 can provide, for display on the device, a team key management interface 604 (e.g., a GUI) for generating and displaying a team recovery key 616. Specifically, the team key management interface 604 can include a notification 614 that can state that the team recovery key is, was, or will be generated. For example, the notification 614 can read, “Generate your team's recovery key.” In some embodiments, the team key management interface 604 includes a notification that, for instance, the team recovery key 616 is a unique code that belongs only to the device (or a user of the device) and/or that the team recovery key 616 should not be shared. Additionally or alternatively, the notification can state that the team recovery key 616 will rarely need to be used, but that the team recovery key 616 is essential to recover access if the device (or the user) is ever locked out of encrypted content.

In one or more embodiments, the team key management interface 604 includes the team recovery key 616. In the same or additional embodiments, the team key encryption system 100 provides, for display on the device via the team key management interface 604, a selectable element 618 for copying the team recovery key 616. In some cases, the team key encryption system 100 can provide, for display on the device via the team key management interface 604, a notification that can state, for example, that the team recovery key 616 is the user's responsibility. Additionally or alternatively, the notification can state that no content management system or server associated with the team key encryption system 100 will store the team recovery key 616 and cannot help the user recover it. In at least one embodiment, the team key encryption system 100 provides, for display on the device, one or more selectable elements, including, but not limited to, a selectable element 620 for canceling the end-to-end encryption setup (or initialization), a selectable element 622 for returning back to the team key management interface 602, and/or a selectable element 624 for progressing to the next stage of the end-to-end encryption setup (or initialization).

As shown in FIG. 6B, based on selecting the selectable element 624, the team key encryption system 100 can provide, for display on the device, a team key management interface 626 (e.g., a GUI) for storing the team recovery key 616. In particular, the team key management interface 626 can include a notification 630 of an instruction to store the team recovery key 616. In some embodiments, the team key encryption system 100 can provide a notification that instructs to paste the team recovery key 616 somewhere private on the device or elsewhere, and/or to print the team recovery key 616 and to store it somewhere safe.

In one or more embodiments, the team key encryption system 100 the team key management interface 626 includes a notification 632 for the user account to verify that the team recovery key 616 is stored. In at least one embodiment, the team key management interface 626 includes the team recovery key 616. In the same or additional embodiments, the team key management interface 626 includes a space 634 for entering the specified number of characters (e.g., the last five (5) characters) of the team recovery key 616. In some instances, the team key encryption system 100 provides a selectable element 636 that, upon selection, verifies (or confirms) that the specified number of characters (e.g., the last five (5) characters) entered in the space 634 correspond to a particular portion of the team recovery key 616. In at least one embodiment, the team key encryption system 100 provides, for display on the device, one or more other selectable elements, including, but not limited to, a selectable element 638 for canceling the end-to-end encryption setup (or initialization), a selectable element 640 for returning back to the team key management interface 604, and/or a selectable element 642 for progressing to the next stage of the end-to-end encryption setup (or initialization).

As further shown in FIG. 6B, based on selecting the selectable element 642, the team key encryption system 100 can provide, for display on the device, a team key management interface 628 (e.g., a GUI). For instance, the team key encryption system 100 can provide the team key management interface 628 to review device enrollment (or registration) via automatic device enrollment (or registration). In particular, the team key management interface 628 can include a notification 644 of an instruction to review the automatic device enrollment. In the same or other embodiments, the team key encryption system 100 provides the automatic device enrollment as the default form of device enrollment.

In some cases, the team key management interface 628 includes one or more notifications of: (1) encrypted content is encrypted and decrypted on team members' registered client devices; (2) the client devices register automatically when members are added to encrypted folders; (3) the client devices include computers, mobile devices, and/or web browsers; and/or (4) automatic registration is secure and requires little to no administrator effort. In one or more embodiments, the team key management interface 628 includes a notification 646 that there is a manual device enrollment (or registration) option for individually approving member devices using manual key verification. In some instances, the team key management interface 628 includes a selectable element 648 for opting to set up the manual device enrollment rather than the automatic device enrollment. In at least one embodiment, the team key encryption system 100 provides, for display on the device, one or more other selectable elements, including, but not limited to, a selectable element 650 for canceling the end-to-end encryption setup (or initialization), a selectable element 652 for returning back to the team key management interface 626, and/or a selectable element 654 for finishing (or finalizing) the end-to-end encryption setup (or initialization) by way of the automatic device enrollment. In some cases, selecting device enrollment (or registration) via automatic device enrollment (or registration) does not automatically exclude an option for manual device enrollment; such an option for manual device enrollment may remain possible.

As illustrated in FIG. 6C, based on selecting the selectable element 648 for opting to set up the manual device enrollment, the team key encryption system 100 can provide, for display on the device, a team key management interface 656 (e.g., a GUI). For example, the team key encryption system 100 can provide the team key management interface 656 to review device enrollment (or registration) via the manual device enrollment (or registration). In particular, the team key management interface 656 includes a notification 660 indicating the manual device enrollment and, in some cases, one or more additional notifications. As an example, the one or more additional notifications can state that: (1) registering client devices involves approving and enrolling (or registering) the client devices by verifying two keys (or two sets of key fingerprints) corresponding to a team key and a device key; (2) the manual device enrollment can be a multi-step process (e.g., a seven-step process) that must be repeated for every device; (3) the automatic device enrollment is strongly encourage; (4) the manual device enrollment requires high, ongoing effort for both administrators and members; (5) both the automatic device enrollment and the manual device enrollment are highly secure; and/or (6) some users may want to use the manual device enrollment for explicit control.

In the same or other embodiments, the team key encryption system 100 provides, for display on the device via the team key management interface 656, a notification 662 that states that the user understands that the manual device enrollment requires high effort and that the user chooses to proceed. In some instances, the notification 662 is accompanied by a selectable element 664 for continuing to set up the manual device enrollment and disabling automatic device enrollment. In one or more embodiments, the team key management interface 656 includes a notification 666 that the user account wants to choose the automatic device enrollment (which the team key encryption system 100 can recommend). In some embodiments, the notification 666 can be accompanied by a selectable element 668 for choosing the automatic device enrollment rather than the manual device enrollment. In one or more embodiments, the team key encryption system 100 provides, for display on the device, one or more other selectable elements, including, but not limited to, a selectable element 670 for canceling the end-to-end encryption setup (or initialization) and/or a selectable element 672 for returning back to the team key management interface 628.

As further illustrated in FIG. 6C, based on selecting the selectable element 664 for continuing to set up the manual device enrollment, the team key encryption system 100 can provide, for display on the device, a team key management interface 658 (e.g., a GUI). For instance, the team key encryption system 100 can provide the team key management interface 658 to review and finalize device enrollment via the manual device enrollment. In particular, the team key management interface 658 includes the notification 660 and the one or more additional notifications. In one or more embodiments, the team key management interface 658 includes a notification 674 to copy a team key 676 and to share the team key with the client devices (or team members) associated with the team. In the same or other embodiments, the team key management interface 658 includes the team key 676 and, in some cases, a selectable element 678 for copying the team key 676. In at least one embodiment, the team key encryption system 100 provides, for display on the device, one or more other selectable elements, including, but not limited to, a selectable element 680 for canceling the end-to-end encryption setup (or initialization), a selectable element 682 for returning back to the team key management interface 656, and/or a selectable element 684 for finishing (or finalizing) the end-to-end encryption setup (or initialization) by way of the manual device enrollment.

As mentioned above, the team key encryption system 100 can utilize one or more team folders (and/or team subfolders) to manage and protect team content. FIG. 7 illustrates an example user interface for creating a team folder for team content that may be encrypted end-to-end in accordance with one or more embodiments.

As illustrated in FIG. 7, the team key encryption system 100 can provide, for display on a device (e.g., an administrator device) associated with a team of client devices, a graphical user interface (GUI) 702 for creating a team folder (and/or a team subfolder). In particular, the team key encryption system 100 can provide, for display on the device via the GUI 702, a space 704 for inserting a name for the team folder. For example, the team folder can be named “Human Resources.” In one or more embodiments, the team key encryption system 100 can provide, for display on the device via the GUI 702, one or more selectable options for selecting which client devices (or user accounts) can be granted access to the team folder.

For instance, the team key encryption system 100 can provide, for display on the device via the GUI 702, a selectable option 706 for everyone on the team (e.g., Team AB) to be able to access the team folder and/or a selectable option 708 for specific people (e.g., specific people associated with the team) to be able to access the team folder. In the same or other embodiments, the team key encryption system 100 can provide, for display on the device via the GUI 702, one or more other selectable options for the folder. For example, the team key encryption system 100 can provide, for display on the device via the GUI 702, a selectable option 710 to sync the team folder to the team's desktop folder and/or a selectable option 712 to encrypt the team folder end-to-end. In at least one embodiment, the GUI 702 includes one or more selectable elements, including, but not limited to, a selectable element 714 for canceling creating the team folder and/or a selectable element 716 for finalizing the creation of the team folder.

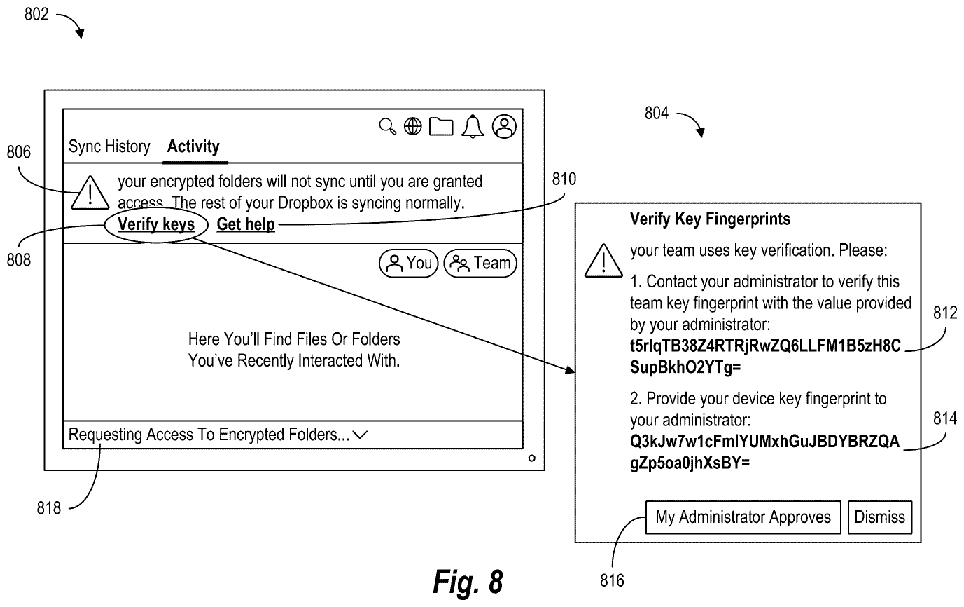

As mentioned above, in one or more embodiments, the team key encryption system 100, as part of manual device enrollment (and/or automatic device enrollment), causes one or more devices (e.g., an administrator device and/or a client device) associated with a team of client devices to verify (or compare) key fingerprints. In particular, to enroll a client device into a team of client devices (e.g., via manual device enrollment), the team key encryption system 100 can cause the one or more devices to verify (or compare) that team key fingerprints associated with a team key match and that device key fingerprints associated with a device key match. FIG. 8 illustrates an example user interface for verifying key fingerprints in accordance with one or more embodiments.

As illustrated in FIG. 8, the team key encryption system 100 can provide, for display on a client device associated with a team of client devices, a graphical user interface (GUI) 802 for notifying the client device (or a user account) of the need to be granted access to team content. In particular, the GUI 802 can include a notification 806 to notify the client device (or the user account) that one or more encrypted folders will not sync until the client devices (or the user account) is granted access by a device (e.g., an administrator device) associated with the team. The GUI 802 can include a selectable element 808 for verifying keys via key fingerprints. In some embodiments, the GUI 802 includes at least one additional element, such as a selectable element 810 for getting help and/or a status indicator 818 showing the state or condition (e.g., what is taking place) on the GUI 802. As an example, the status indicator 818 indicates that the team key encryption system 100 is requesting access to encrypted folders.

As further illustrated in FIG. 8, upon selection of selectable element 808, the team key encryption system 100 can provide, for display on the client device, a graphical user interface (GUI) 804 for verifying key fingerprints. In particular, the GUI 804 can include a notification for the client device (or the user account) to have the client device (or the user account) verify (or initiate the verification of) key fingerprints. For example, the team key encryption system 100 determines a device key fingerprint 814 for the device key and a team key fingerprint 812 for the team key. In the same or other embodiments, the team key encryption system 100 generates the team key fingerprint 812 for an encrypted team key. In some cases, the notification displayed on GUI 804 directs the client device (or the user account) to contact the administrator device to have the administrator device transfer a team key fingerprint (e.g., a value) to the client device so that the client device can verify that the team key fingerprint 812 matches the team key fingerprint provided by the administrator device. In the same or other embodiments, notification displayed on the GUI 804 directs the client device (or the user account) to provide the device key fingerprint 814 associated with the client device to the administrator device for the administrator device to verify that a device key fingerprint calculated and displayed on the administrator device matches the device key fingerprint 814 provided by the client device. In the same or other embodiments, the GUI 804 includes a selectable element 816 for verifying that the client device's administrator approves.

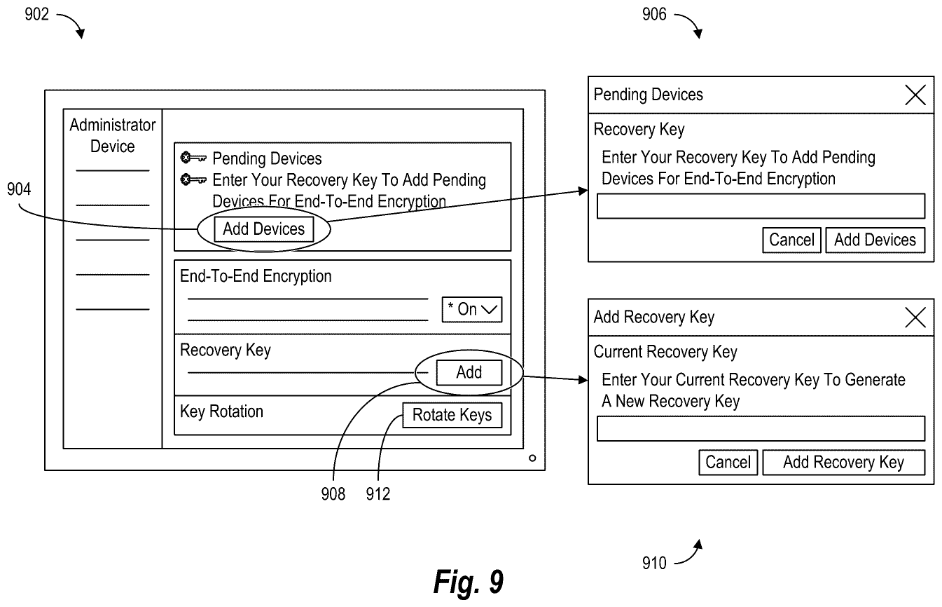

As mentioned above, in one or more embodiments, the team key encryption system 100 causes a device (e.g., an administrator device) associated with a team of client devices to provide a recovery key to access (or regain access to) an encrypted team key. In particular, in some instances, the team key encryption system 100 causes the device (e.g., an administrator device) to enter a recovery key to re-encrypt a team key (or generate an encrypted team key). FIG. 9 illustrates an example user interface of an administrator device, for example, that permits adding a pending client device to end-to-end encryption and replacing a recovery key in accordance with one or more embodiments.

As illustrated in FIG. 9, the team key encryption system 100 can provide, within a graphical user interface (GUI) 902 of a device (e.g., an administrator device) associated with a team of client devices, a selectable element 904 to enter a recovery key to add a pending client device for end-to-end encryption (e.g., via manual device enrollment). In particular, based on selecting the selectable element 904, the team key encryption system 100 can provide, for display in the GUI 902 of the device, a window 906 that contains a space to enter the recovery key to add the pending client device for end-to-end encryption. The team key encryption system 100, in one or more embodiments, provides one or more selectable elements within the window 906 to, for example, cancel adding the pending client devices for end-to-end encryption or add the pending client devices for end-to-end encryption. Based on entering the recovery key into the space and selecting a selectable element to add the pending client devices for end-to-end encryption, the team key encryption system 100 encrypts a (private) team key with a (public) device key of the pending client device. In some instances, upon encrypting the (private) team key with the (public) device key, the team key encryption system 100 can display, in the GUI 902 of the device (e.g., the administrator device), a success notification (e.g., “Client device(s) have been enrolled).

As also illustrated in FIG. 9, the GUI 902 includes a selectable element 908 to add (or generate) a new recovery key. Specifically, based on selecting the selectable element 908, the team key encryption system 100 can provide a window 910 that contains a space to enter the recovery key in order to add (or generate) the new recovery key. The team key encryption system 100, in one or more embodiments, provides one or more selectable elements within the window 910 to cancel adding (or generating) the new recovery key, or to add (or generate) the new recovery key. In some embodiments, the team key encryption system 100 can, upon adding (or generating) the new recovery key, replace an existing recovery key with the new recovery key.

As further illustrated in FIG. 9, the GUI 902 includes a selectable element 912 to rotate keys. In particular, the team key encryption system 100 can, upon selecting the selectable element 912, rotate one or more keys. Indeed, selecting the selectable element 912 can constitute command from a device (e.g., an administrator device associated with the team of client devices) to change a shared encryption key (e.g., a manual request to rotate an encryption key), as described above in relation to FIG. 5.

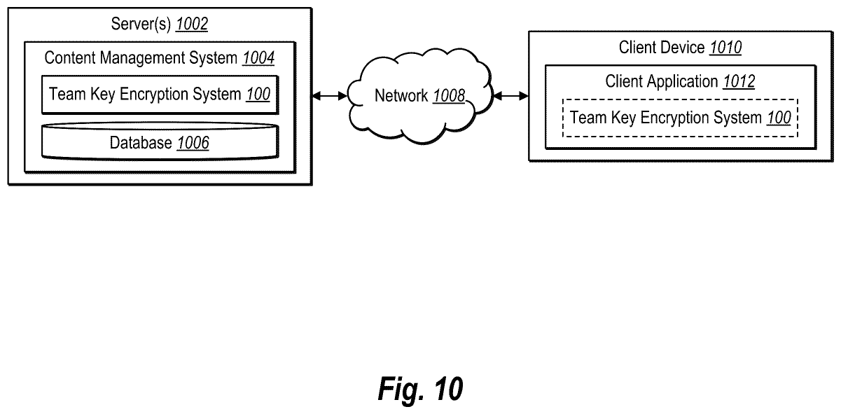

In some embodiments, the team key encryption system 100 is part of a networking environment. In particular, the team key encryption system 100 is part of a content management system hosted on a distributed networking environment that includes servers and devices communicating one or more a computer networks. For example, FIG. 10 illustrates a diagram of an example environment in which a team key encryption system can operate in accordance with one or more embodiments.

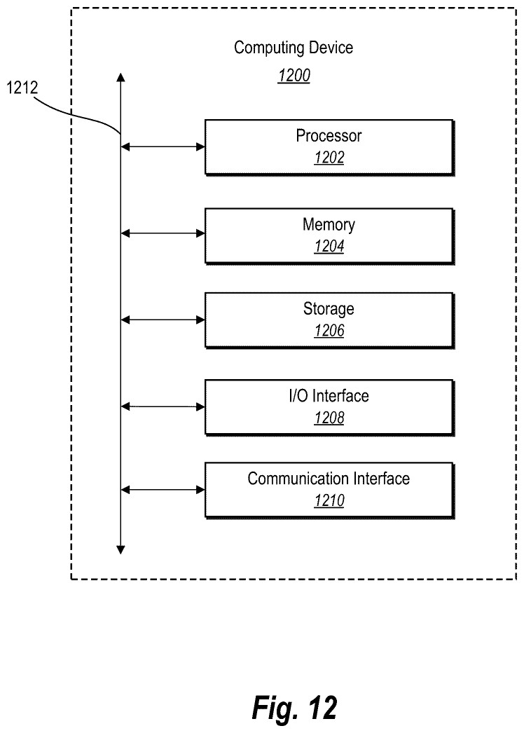

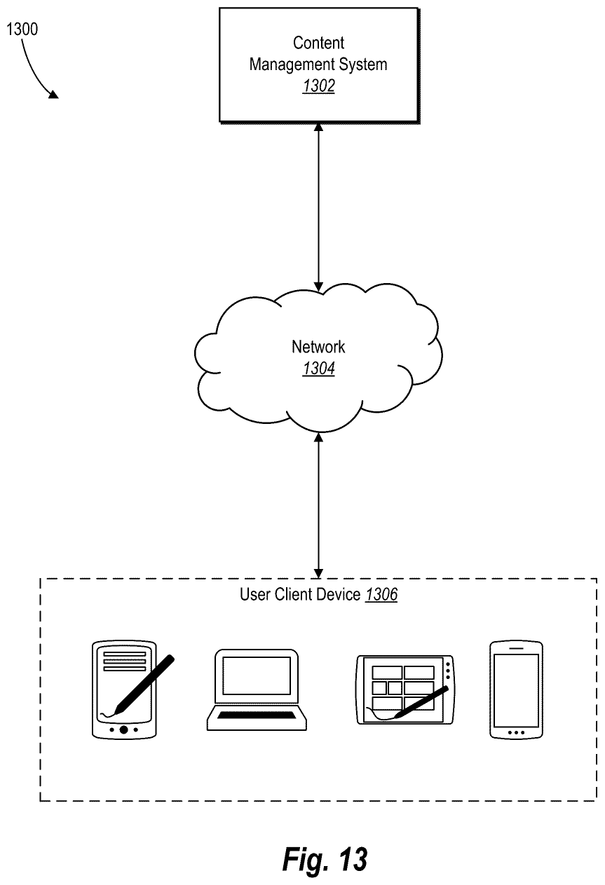

As shown, the environment includes server(s) 1002, client device 1010, and a network 1008. Each of the components of the environment can communicate via the network 1008, and the network 1008 may be any suitable network over which computing devices can communicate. Example networks are discussed in more detail below in relation to FIGS. 12-13.

As mentioned above, the example environment includes a client device 1010. The client device 1010 can be one of a variety of computing devices, including a smartphone, a tablet, a smart television, a desktop computer, a laptop computer, a virtual reality device, an augmented reality device, or another computing device as described in relation to FIGS. 12-13. The client device 1010 can communicate with the server(s) 1002 via the network 1008. For example, the client device 1010 can receive user input from a user interacting with the client device 1010 (e.g., via the client application 1012) to, for instance, access, generate, modify, or share a content item, to collaborate with a co-user of a different client device, or to select a graphical user interface element. In addition, the team key encryption system 100 on the server(s) 1002 can receive information relating to various interactions with content items and/or graphical user interface elements based on the input received by the client device 1010 (e.g., to set up team-based encryption for team content or request enrollment to a team of devices).

As shown, the client device 1010 can include a client application 1012. In particular, the client application 1012 may be a web application, a native application installed on the client device 1010 (e.g., a mobile application, a desktop application, etc.), or a cloud-based application where all or part of the functionality is performed by the server(s) 1002. Based on instructions from the client application 1012, the client device 1010 can present or display information, including a team key encryption interface for providing the client device 1010 access to team content and generating and managing a stratified key structure comprising encrypted keys for a team of client devices.

As illustrated in FIG. 10, the example environment also includes the server(s) 1002. The server(s) 1002 may generate, track, store, process, receive, and transmit electronic data, such as digital content items, encryption keys, enrollment requests, key transmission requests, interface elements, interactions with and changes to digital content items, interactions with interface elements, and/or interactions between user accounts or client devices. For example, the server(s) 1002 may receive data from the client device 1010 in the form of user interactions with interface elements and/or digital data for providing the client device 1010 access to the team content and generating and managing the stratified key structure comprising the encrypted keys for the team. In addition, the server(s) 1002 can transmit data to the client device 1010 in the form of the team key encryption interface for providing the client device 1010 access to the team content and generating and managing the stratified key structure comprising the encrypted keys for the team. Indeed, the server(s) 1002 can communicate with the client device 1010 to send and/or receive data via the network 1008. In some implementations, the server(s) 1002 comprise(s) a distributed server where the server(s) 1002 include(s) a number of server devices distributed across the network 1008 and located in different physical locations. The server(s) 1002 can comprise one or more content servers, application servers, communication servers, web-hosting servers, machine learning server, and other types of servers.

As shown in FIG. 10, the server(s) 1002 can also include the team key encryption system 100 as part of a content management system 1004. The content management system 1004 can communicate with the client device 1010 to perform various functions associated with the client application 1012 such as managing user accounts, managing content collections, managing content items, and facilitating user interaction with the content collections and/or content items. Indeed, the content management system 1004 can include a network-based smart cloud storage system to manage, store, and maintain content items and related data across numerous user accounts, including user accounts in collaboration with one another. In some embodiments, the team key encryption system 100 and/or the content management system 1004 utilize a database 1006 to store and access information such as digital content items, user account behavior data, and encrypted keys.

Although FIG. 10 depicts the team key encryption system 100 located on the server(s) 1002, in some implementations, the team key encryption system 100 may be implemented by (e.g., located entirely or in part on) one or more other components of the environment. For example, the team key encryption system 100 may be implemented by the client device 1010 and/or a third-party device. For example, the client device 1010 can download all or part of the team key encryption system 100 for implementation independent of, or together with, the server(s) 1002.

In some implementations, though not illustrated in FIG. 10, the environment may have a different arrangement of components and/or may have a different number or set of components altogether. For example, the client device 1010 may communicate directly with the team key encryption system 100, bypassing the network 1008. As another example, the environment can include the database 1006 located external to the server(s) 1002 (e.g., in communication via the network 1008) or located on the server(s) 1002, on a third-party system, and/or on the client device 1010. As yet another example, the environment can include a third-party server hosting a large language model in communication with the team key encryption system 100.

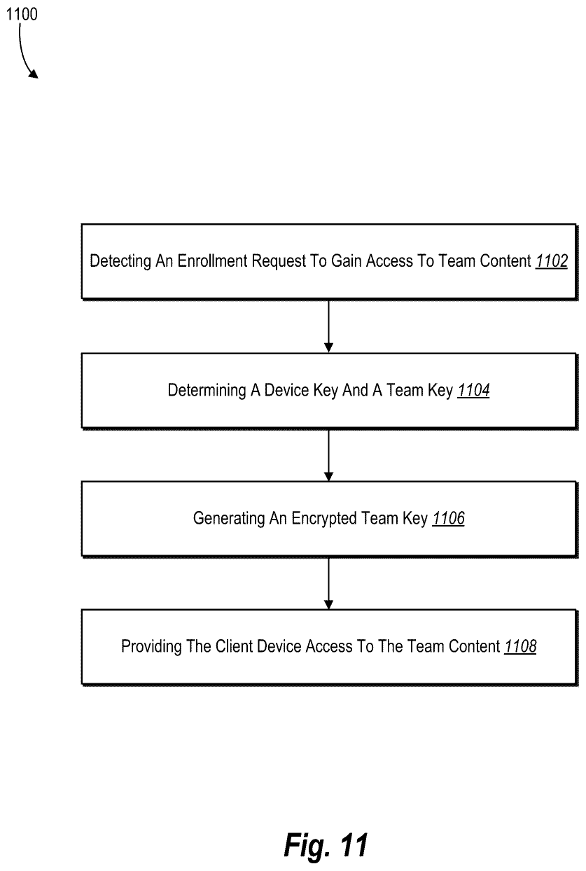

FIGS. 1-10, the corresponding text, and the examples provide a number of different systems and methods for generating and managing a team key and other keys associated with a stratified key structure. In addition to the foregoing, implementations can also be described in terms of flowcharts comprising acts steps in a method for accomplishing a particular result. For example, FIG. 11 illustrates an example series of acts for providing a client device access to team content in accordance with one or more embodiments. While FIG. 11 illustrates acts according to certain implementations, alternative implementations may omit, add to, reorder, and/or modify any of the acts shown in FIG. 11. The acts of FIG. 11 can be performed as part of a method. Alternatively, a non-transitory computer readable medium can comprise instructions that, when executed by one or more processors, cause a computing device to perform the acts of FIG. 11. In still further implementations, a system can perform the acts of FIG. 11.

As illustrated in FIG. 11, the series of acts 1100 may include an act 1102 of detecting an enrollment request to gain access to team content. In particular, the act 1102 involves detecting, from a client device, an enrollment request to gain access to team content associated with a team of client devices associated with a content management system. The series of acts 1100 can also include an act 1104 of determining a device key and a team key. In particular, the act 1104 can involve, in response to the enrollment request, determining a device key associated with the client device and a team key associated with the team. In addition, the series of acts 1100 can include an act 1106 of generating an encrypted team key. In particular, the act 1106 can involve generating an encrypted team key by encrypting the team key with the device key associated with the client device. Further, the series of acts 1100 can include an act 1108 of providing the client device access to the team content. In particular, the act 1108 can involve providing the client device access to the team content by providing the encrypted team key to the client device.

In some embodiments, the series of acts 1100 includes an act of providing the client device access to the team content by decrypting the team content using the encrypted team key; and preventing additional client devices not belonging to the team from accessing the team content. The series of acts 1100 can also include an act of generating the encrypted team key by: selecting, using an automatic enrollment algorithm, one or more team devices within the team to encrypt the team key with the device key of the client device; and causing, using the automatic enrollment algorithm, the one or more team devices to encrypt the team key with the device key.

In some embodiments, the series of acts 1100 includes an act of the automatic enrollment algorithm: determining a number of team devices within the team to select for satisfying a threshold probability of enrolling the client device; and selecting, from among the number of team devices, the one or more team devices according to a time delay for generating the encrypted team key. In the same or other embodiments, the series of acts 1100 includes an act of generating the encrypted team key by: providing the enrollment request to an administrator device associated with the team of client devices; and causing the administrator device to encrypt the team key with the device key associated with the client device.

In one or more embodiments, the series of acts 1100 includes an act of verifying the encrypted team key for the client device by: generating a team key fingerprint for the encrypted team key; and sending the team key fingerprint to the client device for verification of the encrypted team key. The series of acts 1100 can also include an act of detecting a loss of the encrypted team key from a first enrolled client device within the team of client devices; and based on detecting the loss of the encrypted key, instructing a second enrolled client device within the team of client devices to transmit the encrypted team key to the first enrolled client device. In the same or other embodiments, the series of acts 1100 includes an act of generating, based on detecting a change to the team of client devices, a new team key for a currently enrolled client device that is associated with a modified team resulting from the change, and replacing the team key associated with the team with the new team key associated with the modified team.

Additionally, the series of acts 1100 can include an act of generating a stratified key structure by: generating the encrypted team key as an asymmetric encryption key by combining a public device key with a private team key; and generating a set of additional encryption keys comprising symmetric encryption keys and asymmetric encryption keys at respective levels within the stratified key structure. The series of acts 1100 can also include an act of generating the stratified key structure by generating, as part of the set of additional encryption keys, a client device key, a namespace key, a file key, and a revision key. Additionally, in some embodiments, the encrypted team key is asymmetric within the stratified key structure.

In one or more embodiments, the series of acts 1100 includes an act of generating, as part of the set of the additional encryption keys within the stratified key structure, a recovery key that is associated with the encrypted team key and which provides access to the encrypted team key. In certain embodiments, the series of acts 1100 includes an act of generating, as part of the set of additional encryption keys within the stratified key structure, a namespace key associated with a team folder; and encrypting file keys for files in the team folder using the namespace key.

In at least one embodiment, the series of acts 1100 includes an act of generating, as part of the set of the additional encryption keys within the stratified key structure, a file key associated with a file in a team folder; and encrypting revision keys for the file using the file key. Additionally, in some cases, the series of acts 1100 can include an act of generating, as part of the set of the additional encryption keys within the stratified key structure, a revision key associated with a change of a file in a team folder; and encrypting file contents of the change using the revision key.

In some embodiments, the series of acts 1100 includes an act of providing, for display on an administrator device associated with the team, a team key management interface depicting a first selectable option for manual enrollment into the team and a second selectable option for automatic enrollment into the team. The series of acts 1100 can also include an act of detecting a loss of the encrypted team key from a first enrolled client device within the team; determining a number of team devices within the team to select for satisfying a threshold probability of transmitting the encrypted team key to the first enrolled client device; and selecting, from among the number of team devices, one or more other enrolled client devices according to a time delay that offsets respective requests to the one or more other enrolled client devices for transmitting the encrypted team key to the first enrolled client device. The series of acts 1100 can further include an act of detecting, from a new client device, a request to join the team of client devices; and based on detecting the request, instructing an enrolled client device within the team of client devices to provide the encrypted team key to the new client device according to an automatic enrollment algorithm.

The components of the team key encryption system 100 can include software, hardware, or both. For example, the components of the team key encryption system 100 can include one or more instructions stored on a computer-readable storage medium and executable by processors of one or more computing devices. When executed by one or more processors, the computer-executable instructions of the team key encryption system 100 can cause a computing device to perform the methods described herein. Alternatively, the components of the team key encryption system 100 can comprise hardware, such as a special purpose processing device to perform a certain function or group of functions. Additionally or alternatively, the components of the team key encryption system 100 can include a combination of computer-executable instructions and hardware.

Furthermore, the components of the team key encryption system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the team key encryption system 100 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of an example computing device 1200 (e.g., the server(s) 1002 and/or the client device 1010) that may be configured to perform one or more of the processes described above. One will appreciate that server(s) 1002 and/or the client device 1010 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an example of computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 13 is a schematic diagram illustrating environment 1300 within which one or more implementations of the team key encryption system 100 can be implemented. For example, the team key encryption system 100 may be part of a content management system 1302 (e.g., the content management system 1302). Content management system 1302 may generate, store, manage, receive, and send digital content (such as digital content items). For example, content management system 1302 may send and receive digital content to and from client device 1306 and/or other client devices by way of network 1304. In particular, content management system 1302 can store and manage a collection of digital content. Content management system 1302 can manage the sharing of digital content between computing devices associated with a plurality of users. For instance, content management system 1302 can facilitate a user sharing a digital content with another user of content management system 1302.

In particular, content management system 1302 can manage synchronizing digital content across multiple client devices associated with one or more users. For example, a user may edit digital content using client device 1306. The content management system 1302 can cause client device 1306 to send the edited digital content to content management system 1302. Content management system 1302 then synchronizes the edited digital content on one or more additional computing devices.

In addition to synchronizing digital content across multiple devices, one or more implementations of content management system 1302 can provide an efficient storage option for users that have large collections of digital content. For example, content management system 1302 can store a collection of digital content on content management system 1302, while the client device 1306 only stores reduced-sized versions of the digital content. A user can navigate and browse the reduced-sized versions (e.g., a thumbnail of a digital image) of the digital content on client device 1306. In particular, one way in which a user can experience digital content is to browse the reduced-sized versions of the digital content on client device 1306.

Another way in which a user can experience digital content is to select a reduced-size version of digital content to request the full- or high-resolution version of digital content from content management system 1302. In particular, upon a user selecting a reduced-sized version of digital content, client device 1306 sends a request to content management system 1302 requesting the digital content associated with the reduced-sized version of the digital content. Content management system 1302 can respond to the request by sending the digital content to client device 1306. Client device 1306, upon receiving the digital content, can then present the digital content to the user. In this way, a user can have access to large collections of digital content while minimizing the amount of resources used on client device 1306.

Client device 1306 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1304.

Network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client device 1306 and/or other client devices may access content management system 1302.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

Other figures should describe the invention at its root and include all the different variations or embodiments mentioned in the disclosure documents and the disclosure meeting. Please review the disclosure documents and the disclosure meeting transcript when you are done drafting to make sure that the specification describes all of the features and embodiments disclosed by the inventors.

What is claimed is:

1. A computer-implemented method comprising:
detecting, from a client device, an enrollment request to gain access to team content associated with a team of client devices associated with a content management system;
in response to the enrollment request, determining a device key associated with the client device and a team key associated with the team;
generating an encrypted team key by encrypting the team key with the device key associated with the client device; and
providing the client device access to the team content by sending the encrypted team key to the client device.

2. The computer-implemented method of claim 1, further comprising:
providing the client device access to the team content by decrypting the team content using the encrypted team key; and
preventing additional client devices not belonging to the team from accessing the team content.

3. The computer-implemented method of claim 1, wherein generating the encrypted team key comprises:
selecting, using an automatic enrollment algorithm, one or more team devices within the team to encrypt the team key with the device key of the client device; and
causing, using the automatic enrollment algorithm, the one or more team devices to encrypt the team key with the device key.

4. The computer-implemented method of claim 3, wherein the automatic enrollment algorithm comprises:
determining a number of team devices within the team to select for satisfying a threshold probability of enrolling the client device; and
selecting, from among the number of team devices, the one or more team devices according to a time delay for generating the encrypted team key.

5. The computer-implemented method of claim 1, wherein generating the encrypted team key comprises:
providing the enrollment request to an administrator device associated with the team of client devices; and
causing the administrator device to encrypt the team key with the device key associated with the client device.

6. The computer-implemented method of claim 1, further comprising verifying the encrypted team key for the client device by:
generating a team key fingerprint for the encrypted team key; and
sending the team key fingerprint to the client device for verification of the encrypted team key.

7. The computer-implemented method of claim 1, further comprising:
detecting a loss of the encrypted team key from a first enrolled client device within the team of client devices; and
based on detecting the loss of the encrypted team key, instructing a second enrolled client device within the team of client devices to transmit the encrypted team key to the first enrolled client device.

8. The computer-implemented method of claim 1, further comprising:
generating, based on detecting a change to the team of client devices, a new team key for a currently enrolled client device that is associated with a modified team resulting from the change, and
replacing the team key associated with the team with the new team key associated with the modified team.

9. A system comprising:
at least one processor; and
at least one non-transitory computer-readable storage medium storing instructions that, when executed by the at least one processor, cause the system to:
detect, from a client device, an enrollment request to gain access to team content associated with a team of a plurality of user accounts associated with a content management system;
in response to the enrollment request, determine a device key associated with the client device and a team key associated with the team;
generate an encrypted team key by encrypting the team key with the device key associated with the client device; and
provide the client device access to the team content by providing the encrypted team key to the client device.

10. The system of claim 9, further comprising instructions that, when executed by the at least one processor, cause the system to generate a stratified key structure by:
generating the encrypted team key as an asymmetric encryption key by combining a public device key with a private team key; and
generating a set of additional encryption keys comprising symmetric encryption keys and asymmetric encryption keys at respective levels within the stratified key structure.

11. The system of claim 10, further comprising instructions that, when executed by the at least one processor, cause the system to generate the stratified key structure by generating, as part of the set of additional encryption keys, a client device key, a namespace key, a file key, and a revision key.

12. The system of claim 11, wherein the encrypted team key is asymmetric within the stratified key structure.

13. The system of claim 10, further comprising instructions that, when executed by the at least one processor, cause the system to generate, as part of the set of additional encryption keys within the stratified key structure, a recovery key that is associated with the encrypted team key and which provides access to the encrypted team key.

14. The system of claim 10, further comprising instructions that, when executed by the at least one processor, cause the system to:
generate, as part of the set of additional encryption keys within the stratified key structure, a namespace key associated with a team folder; and
encrypt file keys for files in the team folder using the namespace key.

15. The system of claim 10, further comprising instructions that, when executed by the at least one processor, cause the system to:
generate, as part of the set of additional encryption keys within the stratified key structure, a file key associated with a file in a team folder; and
encrypt revision keys for the file using the file key.

16. The system of claim 10, further comprising instructions that, when executed by the at least one processor, cause the system to:
generate, as part of the set of additional encryption keys within the stratified key structure, a revision key associated with a change of a file in a team folder; and
encrypt file contents of the change using the revision key.

17. A non-transitory computer-readable medium storing instructions that, when executed by at least one processor, cause a computer system to:
detect, from a client device, an enrollment request to gain access to team content associated with a team of client devices associated with a content management system;
in response to the enrollment request, determine a public device key associated with the client device and a private team key associated with the team;
generate an encrypted team key by encrypting the private team key with the public device key associated with the client device; and
provide the client device access to the team content by providing the encrypted team key to the client device.

18. The non-transitory computer-readable medium of claim 17, further comprising instructions that, when executed by the at least one processor, cause the computer system to provide, for display on an administrator device associated with the team, a team key management interface depicting a first selectable option for manual enrollment into the team and a second selectable option for automatic enrollment into the team.

19. The non-transitory computer-readable medium of claim 17, further comprising instructions that, when executed by the at least one processor, cause the computer system to:
detect a loss of the encrypted team key from a first enrolled client device within the team;
determine a number of team devices within the team to select for satisfying a threshold probability of transmitting the encrypted team key to the first enrolled client device; and
select, from among the number of team devices, one or more other enrolled client devices according to a time delay that offsets respective requests to the one or more other enrolled client devices for transmitting the encrypted team key to the first enrolled client device.

20. The non-transitory computer-readable medium of claim 17, further comprising instructions that, when executed by the at least one processor, cause the computer system to:
detect, from a new client device, a request to join the team of client devices; and
based on detecting the request, instruct an enrolled client device within the team of client devices to provide the encrypted team key to the new client device according to an automatic enrollment algorithm.
